(19) United States
(12) Patent Application Publication
(10) Pub. No.: US 2021/0052464 A1
(43) Pub. Date: Feb. 25, 2021

(54) PENILE PROSTHESIS DEVICE FOR FACILITATING A PLURALITY OF BODILY FUNCTIONS ASSOCIATED WITH A PENIS

(71) Applicant: Alex Just, Boulder, CO (US)

(72) Inventor: Alex Just, Boulder, CO (US)

(21) Appl. No.: 17/001,567

(22) Filed: Aug. 24, 2020

Related U.S. Application Data
(60) Provisional application No. 62/890,443, filed on Aug. 22, 2019.

(51) Int. Cl. A61H 19/00

(52) U.S. Cl. CPC A61H 19/44; A61H 2230/60; A61H 2201/013; A61H 2201/5071; A61H 2201/163; A61H 2201/165; A61H 2201/1238

(57) ABSTRACT

Disclosed herein is a penile prosthesis device for facilitating a plurality of bodily functions associated with a penis, in accordance with some embodiments. Accordingly, the penile prosthesis device includes a penile prosthesis body, an ejaculation system, and a pump system. Further, a base of the penile prosthesis body is in contact with a groin of a user. Further, the ejaculation system may include a lubrication system. Further, the ejaculation system includes a pocket and a hole leading into the pocket. Further, the pocket is configured for dispersing first fluid through the hole. Further, the pump system includes a reservoir and a balloon. Further, the reservoir is configured for transferring fluid to the balloon. Further, the balloon is configured for inflating based on the transferring. Further, a shaft of the penile prosthesis body is configured for transitioning between a flaccid and an erect state based on the inflating and the deflating.

The current application claims a priority to the U.S. Provisional Patent application Ser. No. 62/890,443 filed on Aug. 22, 2019. The current application is filed on Aug. 24, 2020 while Aug. 22, 2020 was on a weekend.

### FIELD OF THE INVENTION

Generally, the present disclosure relates to the field of prosthesis. More specifically, the present disclosure relates to a penile prosthesis device for facilitating a plurality of bodily functions associated with a penis.

### BACKGROUND OF THE INVENTION

In the present society, there has been a growing movement to bring to light issues affecting individuals of the lesbian, gay, bisexual, transgender, and questioning community; in particular, those who are transgender. With issues ranging from the rising cost of healthcare to the high risks of surgical complications, it may be expensive or financially burdensome for a transgender individual to undergo genital surgery or similar; in particular, for those who are transgender men. Although there are devices currently on the market that aim to provide transgender men with a penile prosthesis device, many of these devices serve only a singular function or have a limiting capacity. For instance, some penile prosthesis devices only operate to mimic or replicate sexual functions of a penis, while negating the other bodily functions of the penis like urination. Or, on the other hand, some devices serve to perform the urinary discharge functions of a penis but fail to provide the user with an aesthetic that mimics or replicates the realistic appearance of a penis. Therefore, it is required that there is a device that may perform, mimic, and/or replicate all bodily functions of a penis, while maintaining an appearance that mimics and/or replicates that of a penis.

Existing penile prosthesis devices for facilitating a plurality of bodily functions associated with a penis are deficient with regard to several aspects. Further, current penile prosthesis devices may include an erection rod that is inserted into a urethral cavity of the penile prosthesis devices. Further, the penile prosthesis devices with the erection rod do not perform any one bodily function particularly well.

Therefore, there is a need for improved penile prosthesis device for facilitating a plurality of bodily functions associated with a penis that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a penile prosthesis device for facilitating a plurality of bodily functions associated with a penis, in accordance with some embodiments. Accordingly, the penile prosthesis device may include a penile prosthesis body, an ejaculation system, and a pump system. Further, the penile prosthesis body may include a shaft, a head, a base, and an appendage. Further, the head may be included in a distal end of the penile prosthesis body. Further, the base may be included in a proximal end of the penile prosthesis body. Further, the appendage may be attached to the proximal end. Further, the base may be configured to be in contact with a groin of a user. Further, the ejaculation system may include a lubrication system. Further, the ejaculation system may include at least one pocket and at least one hole leading into the at least one pocket. Further, the at least one pocket may be disposed of in the head. Further, the at least one hole may be disposed on the head. Further, the at least one pocket may include at least one first fluid disposed in the at least one pocket. Further, the at least one pocket may be configured for dispersing the at least one first fluid through the at least one hole based on at least one action receivable by the head. Further, the pump system may be coupled with the penile prosthesis body. Further, the pump system may include at least one reservoir and at least one balloon. Further, the at least one reservoir may be disposed of in an appendage cavity of the appendage. Further, the at least one balloon may be disposed of in a shaft cavity of the shaft. Further, the at least one reservoir may be fluidly coupled with the at least one balloon using at least one fluid coupling mechanism. Further, the at least one reservoir may include at least one fluid. Further, the at least one reservoir may be configured for transferring the at least one fluid to the at least one balloon. Further, the at least one balloon may be configured for inflating based on the transferring. Further, the shaft may be configured for transitioning to an erect state based on the inflating.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is a side cross-sectional view of a penile prosthesis device for facilitating a plurality of bodily functions associated with a penis, in accordance with some embodiments.

FIG. 2 is a side cross-sectional view of the penile prosthesis device for facilitating the plurality of bodily functions associated with the penis, in accordance with some embodiments.

FIG. 3 is a rear cross-sectional view of the penile prosthesis device for facilitating the plurality of bodily functions associated with the penis, in accordance with some embodiments.

FIG. 4 is a front cross-sectional view of a switch valve of a pump system, in accordance with some embodiments.

FIG. 5 is a front cross-sectional view of the switch valve of the pump system, in accordance with some embodiments.

FIG. 6 is a front cross-sectional view of the switch valve of the pump system, in accordance with some embodiments.

FIG. 7 is a front cross-sectional view of a penile prosthesis body with a pump system, in accordance with some embodiments.

FIG. 8 is a top view of a urinary transfer device of a penile prosthesis device, in accordance with some embodiments.

FIG. 9 is a top perspective view of the urinary transfer device of the penile prosthesis device, in accordance with some embodiments.

FIG. 10 is a top view of a urinary transfer device of a penile prosthesis device, in accordance with some embodiments.

FIG. 11 is a schematic of a pump system of a penile prosthesis device, in accordance with some embodiments.

FIG. 12 is a side perspective view of a penile prosthesis body with a urinary transfer device, in accordance with some embodiments.

FIG. 13 is a side perspective view of the penile prosthesis body with a urinary transfer device, in accordance with some embodiments.

FIG. 14 is a rear view of the penile prosthesis body, in accordance with some embodiments.

FIG. 15 is a schematic of a system with a penile prosthesis device, in accordance with some embodiments.

FIG. 16 is a side perspective view of the penile prosthesis body with a stimulator, in accordance with some embodiments.

FIG. 17 is a front perspective view of the penile prosthesis body, in accordance with some embodiments.

FIG. 18 is a side cross-sectional view of a penile prosthesis device for facilitating a plurality of bodily functions associated with a penis, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of a penile prosthesis device for facilitating a plurality of bodily functions associated with a penis, embodiments of the present disclosure are not limited to use only in this context.

Overview:

The present disclosure describes a penile prosthesis device for facilitating a plurality of bodily functions associated with a penis. Further, the penile prosthesis device may be a universal penile prosthesis device. Further, the universal penile prosthesis device contains a penile prosthesis, a urinary cup, and a stimulator. The penile prosthesis mimics the appearance of the penis. The penile prosthesis primarily contains a base, a shaft, a head, and an appendage; which when arranged together resemble the penis. The penile prosthesis also contains a pump system contained within the appendage and shaft of the penile prosthesis. The pump system contains a balloon, a primer, and a reservoir. The pump system contains the balloon within the shaft that, when inflated, expands the shaft and that, when deflated, contracts the shaft. The pump system contains a high-pressure reservoir and a low-pressure reservoir (that acts as a primer) within the appendage. The balloon, the primer, and the reservoir may be connected by tubing where each tube contains a check valve. The pump system contains a switch valve on the tubes that are between the balloon and the reservoir and between the balloon and the primer. The penile prosthesis contains a cavity on the rear of the base for inserting a stimulator. The penile prosthesis contains a channel that extends from the rear of the base to the front of the head and through the shaft. This channel contains a tube that is connected to the urinary cup, at the end of the tube that is adjacent to the rear of the base. The head of the penile prosthesis contains a pocket for containing lubricants that may exit the head via an exit on the head that is located at the tip of the head. The base of the penile prosthesis may be in contact with and conformed to the user's groin area.

Further, the universal penile prosthesis device may be of any shape, size, material, features, type or kind, orientation, location, quantity, components, and arrangements of components. Further, the universal penile prosthesis device may include a material that is strong, durable, tough, medical-grade, hypoallergenic, flexible, pliable, easily washable or cleanable, and/or easily manufacturable. Further, the universal penile prosthesis device may be of a general shape similar to a shape resembling a human penis. Further, the universal penile prosthesis device may be in contact with the groin of a user adjacent to the genitals of a user such that the universal penile prosthesis device, when attached to a user, may replicate the natural feel of a penis to the user. Further, the universal penile prosthesis device may primarily comprise a penile prosthesis, a urinary cup, and a stimulator.

Further, the universal penile prosthesis device may comprise a urinary cup and attachment nose/funnel. The urinary cup may be of any shape, size, material, features, type or kind, orientation, location, quantity, components, and arrangements of components. Further, the urinary cup and attachment nose/funnel may include a material that is similar to and/or compatible with the material of the universal penile prosthesis device. Further, the urinary cup and attachment nose/funnel may be of a kind or type similar to a urinary cup, urinary receptacle, or a urinary transfer device commonly employed by users with female genitalia in which one end of the urinary cup may be mounted adjacent to the genitalia of the user and the other end may be inserted into an end of the channel of the penile prosthesis that is on the rear of the base; thus, allowing urination flow to occur through the universal penile prosthesis device by means of gravitation. Further, the urinary cup may be of a kind or type similar to a urinary cup, urinary receptacle, or a urinary transfer device commonly employed by users with female genitalia in which one end of the urinary cup may be in contact with the urethra of the user and the other end may be inserted into an end of the channel of the penile prosthesis that is on the rear of the base; thus, allowing urination flow to occur through the universal penile prosthesis device without relying on the gravitation due to the vacuum seal between the urinary cup and the user.

Further, the universal penile prosthesis device may comprise a stimulator. The stimulator may be of any shape, size, material, features, type or kind, orientation, location, quantity, components, and arrangements of components. Further, the stimulator may be of a kind or type and/or of features such that the stimulator may provide electrically powered vibration and/or massaging surfaces for engaging the genitalia of a user. Further, one end of the stimulator may be inserted into the cavity of the base of the penile prosthesis.

Further, the universal penile prosthesis device may comprise a penile prosthesis. The penile prosthesis may be of any shape, size, material, features, type or kind, orientation, location, quantity, components, and arrangements of components. Further, the penile prosthesis may include a material that is similar to and/or compatible with the material of the universal penile prosthesis device. Further, the penile prosthesis may be of a general shape similar to the combined shapes of appendages containing a penis and scrotum. Further, the penile prosthesis may be generally mounted adjacent to or near to the groin area and/or genitalia of the user by means of adhesion, vacuum suction, and/or other similar modes of attachment to the skin of the user at or near to the groin area of the user and/or adjacent to the genitalia of the user. Further, the penile prosthesis may primarily comprise a base, a shaft, an appendage, a head, and a pump system.

Further, the base of the penile prosthesis may be of any shape, size, material, features, type or kind, orientation, location, quantity, components, and arrangements of components. Further, the base may include a material that is similar to and/or compatible with the material of the penile prosthesis. Further, the base may be of a shape similar to a concave, circular, and/or disc-like structure. Further, the base may be of a thickness that is less than the diameter of the base. Further, the diameter of the base may be larger than the diameter of the shaft. Further, the surface of the base that is most anterior to the user may be mounted to the user by means that is specified previously. Further, the surface of the base that is least anterior to the user may be affixed to an end of the shaft that is not affixed to the head of the penile prosthesis. Further, the base may comprise a cavity. Further, the cavity may be of any shape, size, material, features, type or kind, orientation, location, quantity, components, and arrangements of components. Further, the cavity may be located on the surface of the base that is most anterior to the user such that the depth of the cavity may be within the shaft of the penile prosthesis. Further, the cavity may be of a shape and/or size similar to the shape and/or size of the stimulator. Further, the stimulator may be inserted into the cavity.

Further, the shaft of the penile prosthesis may be of any shape, size, material, features, type or kind, orientation, location, quantity, components, and arrangements of components. Further, the shaft may include a material that is similar to and/or compatible with the material of the penile prosthesis. Further, the shaft may be located between a surface of the base that is least anterior to the user and a surface of the head that is most anterior to the user such that when the base, shaft, head, and appendage may be combined and arranged together, a shape or a form similar to a penis may be achieved. Further, the shaft may be of a general shape similar to the overall shape of a shaft of a penis that is either in a flaccid state or an erect state. Further, the shaft may be hollow. Further, the shaft may house the balloon of the pump system. Further, the shaft may comprise a channel and a layer of surface features. The layer of surface features may be of any shape, size, material, features, type or kind, orientation, location, quantity, components, and arrangements of components. Further, the layer of surface features may be located on the exterior surface of the shaft. Further, the layer of surface features may include a material that is similar to and/or compatible with the material of the shaft. Further, the material may be similar to a gel-like material that is more replicative of the motions, movements, feels, and other attributes of the skin of the penis. Further, the layer of surface features may be of a type or kind, features, shape, size, and/or components that may replicate the look or appearance of a shaft of the penis.

Further, the shaft may comprise a channel. Further, the channel may be of any shape, size, material, features, type or kind, orientation, location, quantity, components, and arrangements of components. Further, the channel may be located within the shaft. Further, one end of the channel may be located on the surface of the base that is most anterior to the user underneath the cavity and that the other end of the channel may be located on the underside surface of the end of the head that is least anterior to the user such that the fluid, like urine, may pass and flow through the channel from the urinary cup towards and out of the head. Further, the channel may be of a diameter such that an end of the urinary cup may be inserted into the end of the channel that is located on the surface of the base that is most anterior to the user.

Further, the penile prosthesis may comprise a head. Further, the head may be of any shape, size, material, features, type or kind, orientation, location, quantity, components, and arrangements of components. Further, the head may include a material that is similar to and/or compatible with the material of the penile prosthesis. Further, the head may be located and affixed at the end of the shaft that is not affixed to the base. Further, the head may be of a general shape and/or size similar to the overall shape and size of a head of a penis. Further, the head may comprise a hole and a pocket. Further, the pocket may be of any shape, size, material, features, type or kind, orientation, location, quantity, components, and arrangements of components. Further, the pocket may be located within the head before the tip of the head. Further, the pocket may be accessible from the topside edge of the head that is most anterior to the user. Further, the pocket may be of a shape and/or size such that a sizeable quantity of some type or kind of a fluid, like lubricants or other similar items, may be stored within the pocket of the head. The hole may be of any shape, size, material, features, type or kind, orientation, location, quantity, components, and arrangements of components. Further, the hole may be located at the tip of the head on the surface of the head that is least anterior to the user. Further, the hole may be of a diameter that is less than the overall diameter of the head such that the hole may disperse the fluid, like lubricants or other similar items, from the pocket of the head. Further, the hole may be of a depth such that the hole traverses through the head into the pocket of the head. Further, the fluid disposed within the pocket may be dispersed out of the hole of the head when the head of the penile prosthesis may be squeezed.

Further, the penile prosthesis may comprise an appendage. The appendage may be of any shape, size, material, features, type or kind, orientation, location, quantity, components, and arrangements of components. The appendage may include a material that is similar to and/or compatible with the material of the penile prosthesis. The appendage may be located and affixed underneath the end of the shaft that is affixed to the surface of the base that is least anterior to the user. The appendage may be of a general shape and/or size similar to a shape and/or size of a scrotum associated with the penis. The appendage may be hollow. The appendage may house a first reservoir and a second reservoir of the pump system.

Further, the penile prosthesis may comprise a pump system. The pump system may be of any shape, size, material, features, type or kind, orientation, location, quantity, components, and arrangements of components. The pump system may be located internal to the penile prosthesis. The pump system may comprise a first reservoir, a second reservoir, a balloon, a first switch valve, a second switch valve, a first check valve through a third check valve, and a first tube through a third tube.

Further, the pump system may comprise a balloon. The balloon may be of any shape, size, material, features, type or kind, orientation, location, quantity, components, and arrangements of components. The balloon may include a material that is similar to and/or compatible with the material of the penile prosthesis. Further, the material may be leak-proof, airtight, and/or tear-resistant. The balloon may be located within the shaft of the penile prosthesis. Further, the balloon may either inflate or deflate to make the shaft either erect or flaccid, respectively. The balloon may be of a general shape similar to the overall shape of the shaft. Further, the balloon may be of a general size that is slightly less than the overall size of the shaft.

Further, the pump system may comprise a first reservoir. The first reservoir may be of any shape, size, material, features, type or kind, orientation, location, quantity, components, and arrangements of components. The first reservoir may include a material that is similar to and/or compatible with the material of the penile prosthesis. Further, the material may be leak-proof, airtight, and/or tear-resistant. The first reservoir may be located within one half of the appendage and opposite from the second reservoir. The first reservoir may be of a general shape similar to one half of the appendage. Further, the first reservoir may be of a general shape similar to a hollow, sealed sac with a fluid, such that the first reservoir may be squeezed to prime the fluid disposed within the first reservoir towards the second reservoir. Further, the first reservoir may be of a general size that is slightly less than the general size of one half of the appendage. Further, the first reservoir may be of a general size that is larger than the general size of the second reservoir, such that the first reservoir may be akin to a lowly pressurized chamber that, when primed, transfers the fluid from the first reservoir towards the second reservoir to pressurize the second reservoir.

Further, the pump system may comprise a second reservoir. The second reservoir may be of any shape, size, material, features, type or kind, orientation, location, quantity, components, and arrangements of components. The second reservoir may be similar to the first reservoir in material, features, type or kind, orientation, quantity, components, arrangements of components, and shape. The second reservoir may be of a general size that is less than the general size of the first reservoir such that the second reservoir may be akin to a highly pressurized chamber when filled with fluid from the first reservoir. The second reservoir may be located within one half of the appendage that does not contain the first reservoir and opposite from the first reservoir.

Further, the pump system may comprise a first tube through a third tube. The first tube may be of any shape, size, material, features, type or kind, orientation, location, quantity, components, and arrangements of components. The first tube may include a material that is similar to and/or compatible with the material of the balloon of the pump system. The first tube may be of a general shape similar to a hollowed, thin-walled, and cylindrical-like shaped figure. The first tube may be located between the balloon and the first reservoir such that one end of the first tube may be affixed to the end of the balloon that is most anterior to the user while the other end of the first tube may be affixed to the first reservoir. The second tube may be of any shape, size, material, features, type or kind, orientation, location, quantity, components, and arrangements of components. The second tube may be similar to the first tube in shape, size, material, features, type or kind, quantity, components, and arrangements of components. The second tube may be located between the balloon and the second reservoir such that one end of the second tube may be affixed to the end of the balloon that is most anterior to the user while the other end of the second tube may be affixed to the second reservoir. The third tube may be of any shape, size, material, features, type or kind, orientation, location, quantity, components, and arrangements of components. The third tube may be located between the first reservoir and the second reservoir such that one end of the third tube may be affixed to a surface of the first reservoir that is most adjacent to the second reservoir while the other end of the third tube may be affixed to the surface of the second reservoir that is most adjacent to the first reservoir. In an instance, the third check valve without the third tube may be used as an intermediary component between the first reservoir and the second reservoir that would allow fluid to travel from one reservoir to the other and prevent the occurrence of a backflow.

Further, the pump system may comprise a first check valve through a third check valve. The first check valve may be of any shape, size, material, features, type or kind, orientation, location, quantity, components, and arrangements of components. The first check valve may be of a type or kind such that the first check valve may ensure that fluid flows in one singular direction and that no backflow of fluid occurs in an opposing direction. The first check valve may be located within the first tube such that the first check valve may ensure that a fluid flows from the balloon towards the first reservoir and that no backflow occurs from the first reservoir towards the balloon. The second check valve may be of any shape, size, material, features, type or kind, orientation, location, quantity, components, and arrangements of components. The second check valve may be similar to the first check valve in shape, size, material, features, type or kind, quantity, components, and arrangements of components. Further, the second check valve may be located within the second tube such that the second check valve may ensure that a fluid flows from the second reservoir towards the balloon and that no backflow occurs from the balloon towards the second reservoir. The third check valve may be of any shape, size, material, features, type or kind, orientation, location, quantity, components, and arrangements of components. The third check valve may be similar to the second check valve in shape, size, material, features, type or kind, quantity, components, and arrangements of components. The third check valve may be located within the third tube such that the third check valve may ensure that a fluid flows from the first reservoir towards the second reservoir and that no backflow occurs from the second reservoir towards the first reservoir. Further, the pump system may not include the third tube, which in turn could allow the third check valve to be an immediate intermediary component between the first reservoir and the second reservoir.

Further, the pump system may comprise a first switch valve and a second switch valve. The first switch valve may be of any shape, size, material, features, type or kind, orientation, location, quantity, components, and arrangements of components. The first switch valve may be of a type or kind such that the first switch valve may prevent and/or allow passage of a fluid from flowing into and/or out of a chamber or similar object when the first switch valve may be either engaged or disengaged with the first tube. The first switch valve may be located on the first tube such that the first switch valve may prevent fluid from exiting the balloon towards the first reservoir when the first switch valve may be engaged and may allow fluid to flow from the balloon towards the first reservoir when the first switch valve may be disengaged while being accessible from the exterior surface of the base that is most anterior to the user. The second switch valve may be of any shape, size, material, features, type or kind, orientation, location, quantity, components, and arrangements of components. The second switch valve may be similar to the first switch valve in shape, size, material, features, type or kind, quantity, components, and arrangements of components. The second switch valve may be located on the second tube such that the second switch valve may prevent fluid from exiting the second reservoir towards the balloon when the second switch valve may be engaged and may allow fluid to flow from the second reservoir towards the balloon when the second switch valve may be disengaged while being accessible from the exterior surface of the base that is most anterior to the user.

Further, the universal penile prosthesis device may comprise or incorporate additional electronic elements to automate serval functions of the universal penile prosthesis device that mimic bodily functions of a penis, such as implementing a pump system that is powered by hydraulic or pneumatic action in an automated, non-manual manner. Further, the universal penile prosthesis device may comprise wireless communicator device which may wirelessly interact with a wrist-bound smart device that may monitor and relay the heartbeat, heart rate, and/or other bodily signals of the user that may indicate arousal in order for the wireless communicator to facilitate either inflating or deflating of the penile prosthesis of the universal penile prosthesis device. Further, the wireless communicator device may be configured for wirelessly interact with the wrist-bound smart device over a wireless communication medium. Further, the wireless communicator device may be configured for wirelessly interact with the wrist-bound smart device using Bluetooth. Further, the wireless communicator device may be similar to a chip that may be integrated into the base of the penile prosthesis and/or one of the testicles in the scrotum.

Further, the universal penile prosthesis device may comprise a sensor device that is insertable within the user's vagina. The sensor device may communicate with the penile prosthesis when the pelvic floor muscles of the user are voluntarily contracting in order to relay to the penile prosthesis when to inflate and/or deflate the balloon. Further, the sensor device may be inserted into the vagina of a user and may be electrically connected to the pump system of the penile prosthesis. When the female genitalia of the user contracts around the sensor device, the sensor device reads this action by the user as an arousal state and notifies the pump system to inflate the balloon in order to make the penile prosthesis more erect.

Further, the layer of surface features of the penile prosthesis may comprise a plurality of sensors, or other similar electronics, between an inner surface of the layer of surface features and an exterior surface of the shaft such that the plurality of sensors may read and recognize hand pressure on the penile prosthesis that is congruent with the typical motions of enticing a penis into an arousal state of erection in order to notify the pump system to inflate the balloon to have the penile prosthesis in a more erect state.

Further, the present disclosure relates generally to a penile prosthesis device. More specifically, the present disclosure describes a universal penile prosthesis device that may mimic, perform, and/or replicate all bodily functions associate with a penis.

Further, the present disclosure describes a device that may be the universal penile prosthesis device. Further, the present disclosure describes a device that may contain an apparatus that is similar to a penis in both appearance and function. Further, the present disclosure describes a device that contains a pump system that inflates and deflates a shaft of the penile prosthesis device. Further, the present disclosure describes a device that may provide a sufficient means of attaching said device to the user's groin without concern over whether the device remains affixed to the user's groin during normal movement. Further, the present disclosure describes a device that contains a means for stimulating the user. Further, the present disclosure describes a device that contains a means for providing urinary relief to the user through the shaft of the device without concerns of leakage during urination.

Further, the present disclosure describes an attachment. Further, the attachment may be configured for attaching the universal penile prosthesis device to the user. Further, the attachment may be configured for attaching the universal penile prosthesis device using a bone-anchoring system. Further, the attachment may function as a push and twist light socket system. Further, the attachment may include pins and sockets. Further, the pins may be surgically embedded in a pubic bone of the user. Further, the sockets may be disposed on the base of the penile prosthesis. Further, the sockets may be configured for removably receiving the pins for attaching the universal penile prosthesis device to the user.

Further, the pump system of the universal penile prosthesis device may be pneumatic. Further, one of the testicles the universal penile prosthesis device may be a pump. Further, the pumping of a right testicle would inflate the shaft with air that is moving through a check valve in the pump, through a tube into the shaft. Further, the shaft may include a release valve/clamp that releases the pressure from the shaft. Further, one of the testicles may contain a micro CO2 cartridge. Further, pushing a valve associated with the micro CO2 cartridge inflates the shaft. Further, the shaft deflates through the release valve/clamp. Further, the release valve/clamp may auto-release if the pressure in the shaft gets too high.

Further, the universal penile prosthesis device may include an ejaculation system. Further, the ejaculation system may include a lubrication system. Further, the ejaculation system may be configured for ejecting fluid from an ejaculation reservoir. Further, the ejaculation reservoir contains the fluid. Further, the fluid may be a lubricant.

Further, the present disclosure describes a prosthetic penis intended predominantly for transgender men who have not had any genital surgery. Further, the prosthetic penis may be also suitable for natal men who have lost their genitals due to trauma or illness. Further, the prosthetic penis performs three primary functions: 1) Urination—allowing the wearer to stand and urinate, 2) Sexual function—changes state from flaccid to erect and back, and stimulates the wearer's erogenous zone, and 3) Packing—looks like a natural-looking penis in underwear and when naked. Further, the prosthetic penis may include a urethral cavity that travels thought the underside of the shaft of the prosthetic penis (similar in location to a biological urethra on a human penis). Further, the prosthetic penis may include a small urination cup that is plugged into the urethral cavity to allow the urination into the cup and urine flowing through the shaft. The cup may form a seal between itself and the wearer's body to prevent leaking. The cup has a small lip which acts as a spill rim to further prevent leaking. This cup may be removed from the prosthetic penis. Further, the prosthetic penis may provide sexual functions by activating an erection and de-activating the erection. Further, the prosthetic penis moves from flaccid to erect state through a hydraulic system that moves fluid between the shaft and reservoirs that are disposed of in the testicles. Check valves associated with the prosthetic penis ensure a one-directional flow of the fluid in a circular fashion. In the flaccid state, most fluid may be contained in the reservoirs (testicles) that are disposed of in the scrotum. To “prime” the prosthetic penis for an erection, the right hand (low pressure) testicle may be squeezed which forces the fluid through a check valve into the left hand (high pressure) testicle. Once the valve between the high-pressure reservoir and the shaft may be opened, fluid may flow from the high-pressure environment to the low-pressure environment through a one-way check valve so as to prevent back-flow. Pressure in the shaft may be further increased by again squeezing the right hand testicle which may now flow the fluid directly into the shaft as the valve between testicle and shaft may be opened (and hence doesn't pressurize the left hand testicle). The shaft has a containment sleeve around it that minimizes expansion widthways and forces the expansion lengthways. To de-actuate, the erection, the valve between the shaft and the low pressure testicle may be opened. The fluid may flow through a check valve from the high pressure environment of the shaft to the low pressure environment of the right hand reservoir (testicle) and the shaft may move back to a flaccid state. The shaft may be squeezed to “wring out” extra fluid to make it extra flaccid. To repeat the cycle, make sure the left hand valve between scrotum and shaft may be closed before squeezing the right hand (low pressure) testicle to again prime the left hand (high pressure) testicle for a next erection. The opening and closing valves may be embedded in the scrotum above the reservoirs (testicles) and may be operated by pushing them open and shut (feeling for them through the skin of the scrotum.). Further, the opening and closing valves may include a dependent valve that slides from one direction to another simultaneously to open one side and closing the other side. Further, the dependent valve may slide to a neutral position closing both sides. Further, a valve may include a sliding rod with holes. This sliding rod may be positioned inside a cylinder that is connected to the hoses. As the sliding rod may be pushed left to right, the holes align with either one of the tube connections. Further, a push to the sliding rod closes the right tube and opens the left tube. Further, a push to the sliding rod closes the left tube and opens the right tube. Further, the sliding rod may be pushed to the neutral position where the holes don't align with either of the tube connections. Further, the sliding rod in the neutral position closes the left tube and the right tube. Further, the prosthetic penis may provide sexual functions by stimulating the wearer. Further, a cavity that is disposed of in the center of the shaft may allow for the insertion of either a remote control bullet vibe that may align with the wearer's clitoris/erogenous zone. Further, silicone plugs with various textured heads may be inserted into this cavity with the textured head for stimulating the wearer. The bullet vibe and textured plugs may be removable and interchangeable. Further, the prosthetic penis may be worn without any adhesion in regular underwear and used as a urination device. However, for sexual play, the prosthetic penis needs to be affixed to the pubic bone or used with modified underwear (consisting of a loop that holds the prosthetic penis in place), a harness, or other strap system. To achieve a natural look, some pubic hair may be harvested from the wearer and that hair may be punched into the pubic plate of the penis prosthetic. The penis prosthetic may be attached to the wearer's shaved pubic bone. Adhesion may be achieved through a sticky silicone backing applied to the back of the pubic plate (a double-sided silicone scar sheets). Further, the sheets may remain sticky for multiple uses but the sheets may be needed to be replaced from time to time. Alternatively, readily available adhesive wipes (such as skintac) and adhesive remover (such as tac-away) may be used to attach the pubic plate to the wearer. For sexual activity, further stabilization of the penis prosthetic may be achieved through the addition of customized underwear that contains a loop in the crotch which loops around the scrotum to hold it in place. For sexual activity, the waistband of the underwear may be lowered below the penile shaft. Hence the loop, the waistband, and the adhesive plate all work together to hold the penis prosthetic firmly in place. For sexual activity, further stabilization of the penis prosthetic may be achieved through a soft silicone O ring that may be looped around the scrotum. This O ring may have two tentacles attached to it that adhere to the inside of the leg. Further, the O ring may include an elastic “jock strap” attached to the O ring that loops around the legs.

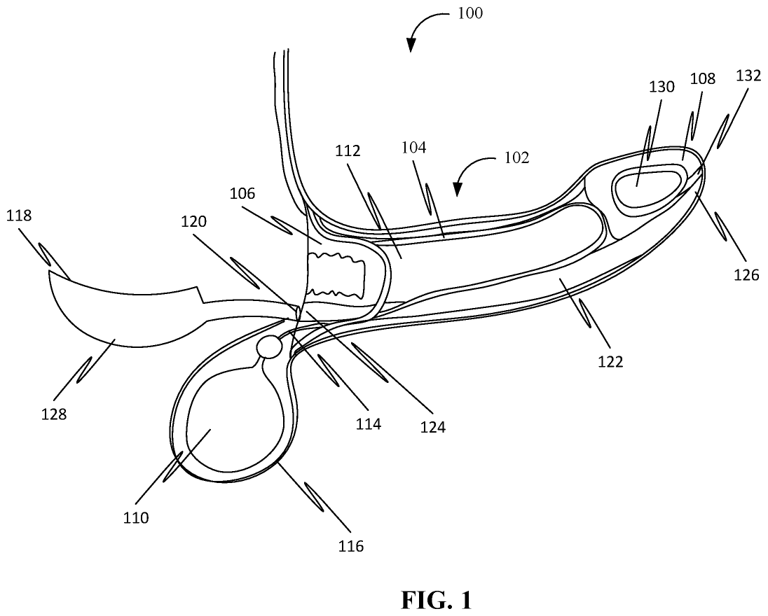

FIG. 1 is a side cross-sectional view of a penile prosthesis device 100 for facilitating a plurality of bodily functions associated with a penis, in accordance with some embodiments. Further, the penile prosthesis device 100 may include a penile prosthesis body 102, an ejaculation system, and a pump system. Further, the plurality of bodily functions may include urinating, stimulating, erecting, etc.

Further, the penile prosthesis body 102 may include a shaft 104, a head 108, a base 106, and an appendage 116. Further, the head 108 may be included in a distal end of the penile prosthesis body 102. Further, the base 106 may be included in a proximal end of the penile prosthesis body 102. Further, the appendage 116 may be attached to the proximal end. Further, the base 106 may be configured to be in contact with a groin of a user.

Further, the ejaculation system may include a lubrication system. Further, the ejaculation system may include at least one pocket 130 and at least one hole 132 leading into the at least one pocket 130. Further, the at least one pocket 130 may be disposed of in the head 108. Further, the at least one hole 132 may be disposed on the head 108. Further, the at least one pocket 130 may include at least one first fluid disposed in the at least one pocket 130. Further, the at least one pocket 130 may be configured for dispersing the at least one first fluid through the at least one hole 132 based on at least one action receivable by the head 108. Further, the at least one action may include at least one squeezing action. Further, the at least one first fluid may include at least one liquid, at least one semi-liquid, at least one gel, etc. Further, the at least one first fluid may include at least one lubricant, at least one ejaculate, etc. Further, the at least one ejaculate may include at least one synthetic semen. Further, the at least one lubricant may include a water-based lubricant, an oil-based lubricant, a silicone-based lubricant, etc.

Further, the pump system may be coupled with the penile prosthesis body 102. Further, the pump system may include at least one reservoir 110 and at least one balloon 112. Further, the at least one reservoir 110 may be disposed of in an appendage cavity of the appendage 116. Further, the at least one balloon 112 may be disposed of in a shaft cavity of the shaft 104. Further, the at least one reservoir 110 may be fluidly coupled with the at least one balloon 112 using at least one fluid coupling mechanism 114. Further, the at least one reservoir 110 may include at least one fluid. Further, the at least one fluid may include at least one liquid, at least one gas, etc. Further, the at least one liquid may include water, liquid gel, etc. Further, the at least one gas may include air, carbon dioxide gas (CO2), etc. Further, the at least one reservoir 110 may be configured for transferring the at least one fluid to the at least one balloon 112. Further, the at least one balloon 112 may be configured for inflating based on the transferring. Further, the shaft 104 may be configured for transitioning to an erect state based on the inflating.

In further embodiments, at least one stimulator may be disposed on the base 106. Further, the at least one stimulator may include at least one stimulating surface. Further, the at least one stimulating surface may be configured for engaging with at least one sexual organ of the user. Further, the at least one sexual organ may include a vagina, a clitoris, a labia, etc. Further, the at least one stimulator provides stimulation to the at least one sexual organ based on the engaging of the at least one stimulating surface with the at least one sexual organ. Further, the engaging of the at least one stimulating surface with the at least one sexual organ may include rubbing, massaging, etc. of the at least one sexual organ. Further, in an embodiment, the at least one stimulator may include a ribbed cavity. Further, the ribbed cavity may be disposed on the base 106. Further, the ribbed cavity may be configured for receiving a portion of the at least one sexual organ. Further, the receiving of the at least one sexual organ in the ribbed cavity provides stimulation to the at least one sexual organ.

Further, in some embodiments, the at least one balloon 112 may be configured for transferring the at least one fluid disposed of in the at least one balloon 112 to the at least one reservoir 110 using the at least one fluid coupling mechanism 114. Further, the at least one balloon 112 may be configured for deflating based on the transferring of the at least one fluid from the at least one balloon 112. Further, the shaft 104 may be configured for transitioning to a flaccid state based on the deflating.

Further, in an embodiment, the shaft 104 may be characterized by at least one of a rigidity and a length. Further, the at least one of the rigidity and the length of the shaft 104 may be greater in the erect state than the at least one of the rigidity and the length of the shaft 104 in the flaccid state.

Further, in some embodiments, the at least one reservoir 110 may be configured for priming the at least one fluid disposed of in the at least one reservoir 110 based on at least one squeezing action receivable by the at least one reservoir 110. Further, the transferring of the at least one fluid from the at least one reservoir 110 to the at least one balloon 112 through the at least one fluid coupling mechanism 114 may be based on the priming.

Further, in an embodiment, the pump system may include at least one check valve coupled with the at least one fluid coupling mechanism 114. Further, the at least one check valve may be configured for ensuring a flow of the at least one fluid in a single direction through the at least one fluid coupling mechanism 114. Further, the at least one check valve may be configured for preventing a backflow of the at least one fluid through the at least one fluid coupling mechanism 114.

Further, in an embodiment, the pump system may include at least one switch valve coupled with the at least one fluid coupling mechanism 114. Further, the at least one switch valve may be configured for transitioning between an engaged state and a disengaged state. Further, the at least one switch valve may be configured for restricting a flow of the at least one fluid through the at least one fluid coupling mechanism 114 in the engaged state. Further, the at least one switch valve may be configured for allowing the flow of the at least one fluid through the at least one fluid coupling mechanism 114 in the disengaged state. Further, in an embodiment, the at least one fluid coupling mechanism 114 may include a first tube and a second tube. Further, the first tube and the second tube may be coupled with the at least one switch valve. Further, the at least one switch valve may be configured for transitioning between a plurality of states. Further, the plurality of states may include a first tube state, a second tube state, and a neutral state. Further, the at least one switch valve in the first tube state allows a flow of the at least one fluid through the first tube and restricts a flow of the at least one fluid through the second tube. Further, the at least one switch valve in the second tube state allows the flow of the at least one fluid through the second tube and restricts the flow of the at least one fluid through the first tube. Further, the at least one switch valve in the neutral state restricts the flow of the at least one fluid through the first tube and the second tube.

Further, in an embodiment, the at least one reservoir 110 may include a first reservoir and a second reservoir. Further, the at least one fluid coupling mechanism 114 may include at least one tube. Further, the first reservoir, the second reservoir, and the at least one balloon 112 may be fluidly coupled using the at least one tube. Further, the at least one tube may include a first tube, a second tube, and a third tube. Further, the first reservoir may be fluidly coupled with the at least one balloon 112 using the first tube and the second reservoir may be fluidly coupled with the at least one balloon 112 using the second tube. Further, the first reservoir may be fluidly coupled with the second reservoir using the third tube. Further, the at least one fluid circulates between the first reservoir, the second reservoir, and the at least one balloon 112. Further, the at least one check valve may be coupled with the at least one tube. Further, the at least one check valve may include a first check valve, a second check valve, and a third check valve. Further, the first check valve may be coupled with the first tube. Further, the second check valve may be coupled with the second tube. Further, the third check valve may be coupled with the third tube. Further, the first check valve may be configured for ensuring a flow of the at least one fluid from the at least one balloon 112 to the first reservoir. Further, the first check valve may be configured for restricting a backflow of the at least one fluid from the first reservoir to the at least one balloon 112. Further, the second check valve may be configured for ensuring a flow of the at least one fluid from the second reservoir to the at least one balloon 112. Further, the second check valve may be configured for restricting a backflow of the at least one fluid from the at least one balloon 112 to the second reservoir. Further, the third check valve may be configured for ensuring a flow of the at least one fluid from the first reservoir to the second reservoir. Further, the third check valve may be configured for restricting a backflow of the at least one fluid from the second reservoir to the first reservoir. Further, the at least one switch valve may include a first switch valve and a second switch valve. Further, the first switch valve may be coupled with the first tube and the second switch valve may be coupled with the second tube. Further, the first switch valve may be configured for preventing a flow of the at least one fluid between the at least one balloon 112 and the first reservoir in the engaged state. Further, the first switch valve may be configured for allowing the flow of the fluid between the at least one balloon 112 and the first reservoir in the disengaged state. Further, the second switch valve may be configured for preventing a flow of the at least one fluid between the second reservoir and the at least one balloon 112 in the engaged state. Further, the second switch valve may be configured for allowing the flow of the at least one fluid between the second reservoir and the at least one balloon 112 in the disengaged state.

Further, in an embodiment, the at least one fluid may be disposed in the first reservoir. Further, the first reservoir may be configured for receiving a squeezing action for priming the at least one fluid. Further, the first reservoir may be configured for transferring the at least one fluid to the second reservoir through the third tube based on the engaged state of the first switch valve. Further, the second reservoir may be configured for transferring the at least one fluid to the at least one balloon 112 through the second tube based on the disengaged state of the second switch valve. Further, the inflating may be based on the transferring of the at least one fluid to the at least one balloon 112. Further, the shaft 104 may be configured for transitioning to the erect state based on the inflating. Further, the at least one balloon 112 transfers the at least one fluid to the first reservoir through the first tube based on the disengaged state of the first switch valve. Further, the shaft 104 may be configured for transitioning to a flaccid state based on the transfer of the at least one fluid from the at least one balloon 112 to the first reservoir.

Further, in an embodiment, the shaft 104 may include at least one containment sleeve disposed around the shaft 104. Further, the at least one containment sleeve may be configured for allowing an expansion of the shaft 104 along a length of the shaft 104 based on the inflating. Further, the at least one containment sleeve may be configured for restricting the expansion of the shaft 104 along a width of the shaft 104 based on the inflating.

Further, in some embodiments, the base 106 may include a disc-shaped structure. Further, a thickness of the disc-shaped structure may be smaller than a diameter of the disc-shaped structure. Further, the diameter of the disc-shaped structure may be larger than a diameter of the shaft 104. Further, the disc-shaped structure may include a concave surface. Further, the concave surface may be attachable with a skin of the groin.

Further, in some embodiments, the at least one switch valve may be configured to move between a plurality of positions. Further, the plurality of positions may include a first position, a second position, and a neutral position. Further, the first switch valve transitions to the disengaged state and the second switch valve transitions to the engaged state in the first position. Further, the first switch valve allows the flow of the at least one fluid and the second switch valve prevents the flow of the at least one fluid in the first position. Further, the first switch valve transitions to the engaged state and the second switch valve transitions to the disengaged state in the second position. Further, the first switch valve prevents the flow of the at least one fluid and the second switch valve allows the flow of the at least one fluid in the second position. Further, the first switch valve transitions to the engaged state and the second switch valve transitions to the engaged state in the neutral position. Further, the first switch valve prevents the flow of the at least one fluid and the second switch valve prevents the flow of the at least one fluid in the neutral position.

Further, in some embodiments, the shaft 104 may include a layer disposed on an exterior surface of the shaft 104. Further, the layer corresponds to a skin of the penis. Further, the layer may include at least one surface feature corresponding to a surface feature of the penis. Further, the layer may include at least one material for replicating at least one attribute of the skin of the penis.

Further, in some embodiments, the at least one pocket 130 may be configured for receiving the at least one first fluid through the at least one hole 132. Further, the at least one pocket 130 may be configured for storing the at least one first fluid. Further, the dispersing of the at least one first fluid through the at least one hole 132 may be based on the storing.

Further, in some embodiments, the penile prosthesis body 102 may include a channel 122 extending from the base 106 to the head 108 along the shaft 104. Further, the channel 122 may include a first channel end 124 and a second channel end 126. Further, the first channel end 124 may be disposed on the base 106 and the second channel end 126 may be disposed on the head 108.

In further embodiments, a urinary transfer device 128 may be coupled with the penile prosthesis body 102. Further, a first end 118 of the urinary transfer device 128 may be in contact with a urethral opening of the user. Further, a second end 120 of the urinary transfer device 128 may be coupled with the first channel end 124. Further, the first end 118 and the second end 120 may be fluidly coupled. Further, the urinary transfer device 128 may be configured for transferring urine discharged from the urethra to the channel 122. Further, the channel 122 may be configured for allowing a flow of the urine from the first channel end 124 to the second channel end 126. Further, in an embodiment, the urinary transfer device 128 may be fixedly coupled with the penile prosthesis body 102. Further, the second end 118 of the urinary transfer device 128 may be fixedly coupled with the first channel end 124. Further, in an embodiment, the urinary transfer device 128 may be detachably coupled with the penile prosthesis body 102. Further, the second end 118 of the urinary transfer device 128 may be detachably coupled with the first channel end 124.

Further, in some embodiments, the pump system may include at least one inflation mechanism. Further, the at least one inflation mechanism may be a hydraulic pumping mechanism, a pneumatic pumping mechanism, etc. Further, the at least one inflation mechanism may be included in the at least one reservoir 110. Further, the at least one inflation mechanism may be configured for performing at least one pumping action. Further, the at least one inflation mechanism may be configured for transferring the at least one fluid from the at least one reservoir 110 to the at least one balloon 112 through the at least one fluid coupling mechanism 114 based on the performing of the at least one pumping action. Further, the at least one fluid may include at least one liquid, at least one gas, etc. Further, the at least one gas may include air. Further, the at least one inflation mechanism may be electrically powered. Further, the pump system may include a power source for powering the at least one inflation mechanism. Further, the power source may be a battery, a power supply, etc.

In further embodiments, the penile prosthesis device 100 may include at least one sensor and a processing device. Further, the at least one sensor may be disposable at least one body part of the user. Further, the at least one sensor may be configured for generating sensor data based on at least one of a physical state and a physiological state of the user. Further, the at least one of the physical state and the physiological state may include a heartbeat rate, a respiration rate, etc. Further, the processing device may be communicatively coupled with the at least one sensor. Further, the processing device may be configured for analyzing the sensor data. Further, the processing device may be configured for determining an arousal state of the user based on the analyzing. Further, the at least one inflation mechanism may be communicatively coupled with the processing device. Further, the performing of the at least one pumping action may be based on the determining of the arousal state.

In further embodiments, the penile prosthesis device 100 may include at least one first sensor and a processing device. Further, the at least one sensor may be disposable in a vagina of the user. Further, the at least one first sensor may be configured for generating first sensor data based on at least one voluntary movement of pelvic floor muscles associated with the vagina. Further, the processing device may be communicatively coupled with the at least one first sensor. Further, the processing device may be communicatively coupled with the at least one first sensor using at least one of a wired connection and a wireless connection. Further, the wired connection may include a cable. Further, the processing device may be configured for analyzing the first sensor data. Further, the processing device may be configured for determining an arousal state of the user based on the analyzing of the first sensor data. Further, the at least one inflation mechanism may be communicatively coupled with the processing device. Further, the performing of the at least one pumping action may be based on the determining of the arousal state. Further, the performing of the at least one pumping action transitions the shaft 104 from a first erect state and a second erect state. Further, the shaft 104 may be characterized by at least one of a rigidity and a length. Further, at least one of a first rigidity and a first length corresponding to the first erect state may be less than at least one of a second rigidity and a second length corresponding to the second erect state. Further, in an embodiment, the at least one first sensor may be disposed within a vaginal insert. Further, the vaginal insert may be inserted in the vagina. Further, the vaginal insert may include a tampon.

In further embodiments, at least one second sensor may be disposed on the shaft 104. Further, the at least one second sensor may be configured for generating second sensor data based on at least one pressure and at least one movement receivable by the shaft 104. Further, the processing device may be configured for analyzing the second sensor data. Further, the determining of the arousal state may be based on the analyzing of the second sensor data.

Further, in some embodiments, the at least one reservoir 110 may include at least one carbon dioxide gas cartridge. Further, the at least one fluid may include carbon dioxide gas. Further, the at least one carbon dioxide gas cartridge may be configured for transferring the carbon dioxide gas to the at least one balloon 112. Further, the inflating may be based on the transferring of the carbon dioxide gas.

Further, in some embodiments, the at least one balloon 112 may include a first balloon and a second balloon. Further, the second balloon may be concentrically disposed around the first balloon in the shaft cavity. Further, the first balloon may be permanently inflated based on the at least one fluid disposed of in the first balloon. Further, the second balloon may be fluidly coupled with the at least one reservoir 110. Further, the second balloon may be configured for inflating based on the transferring of the at least one fluid to the second balloon.

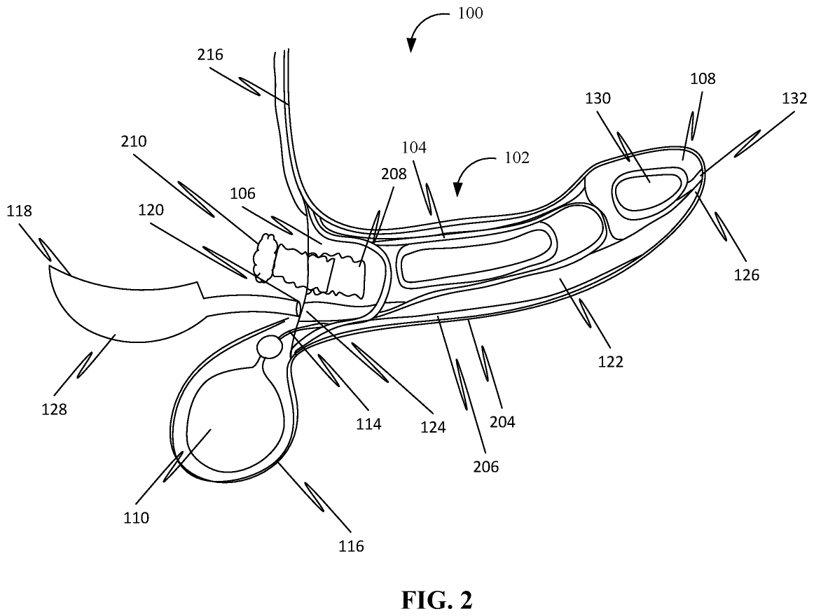

FIG. 2 is a side cross-sectional view of the penile prosthesis device 100 for facilitating the plurality of bodily functions associated with the penis, in accordance with some embodiments. Further, the penile prosthesis device 100 may include the penile prosthesis body 102, the urinary transfer device 128, and the pump system.

Further, the penile prosthesis body 102 may include the shaft 104, the head 108, the base 106, and the appendage 116. Further, the shaft 104 may include a layer 204 disposed on an exterior surface of the shaft 104. Further, the layer 204 corresponds to a skin of the penis. Further, the layer 204 may include at least one surface feature corresponding to a surface feature of the penis. Further, the layer 204 may include at least one material for replicating at least one attribute of the skin of the penis. Further, the shaft 104 may include at least one lubricating layer 206 disposed between the layer 204 and the exterior surface of the shaft 104. Further, the layer 204 may be movable in relation to the shaft 104. Further, the at least one lubricating layer 206 may provide movability to the layer 204.

Further, in an embodiment, the at least one stimulator may include a ribbed cavity 208. Further, the ribbed cavity 208 may include at least one protrusion disposed on a wall of the ribbed cavity 208. Further, the ribbed cavity 208 may be configured for receiving a portion of the at least one sexual organ. Further, the receiving of the portion of the at least one sexual organ in the ribbed cavity 208 provides stimulation to the at least one sexual organ. Further, the at least one sexual organ may be the vagina, the clitoris, the labia, etc. Further, in an embodiment, the at least one stimulator may include at least one silicone plug 210. Further, the at least one silicone plug 210 may include at least one textured surface. Further, the at least one silicone plug 210 provides stimulation to the at least one sexual organ based on the engaging of the at least one textured surface with the at least one sexual organ. Further, the at least one silicone plug 210 may be partially insertable in the ribbed cavity 208. Further, the at least one silicone plug 210 may be removably insertable in the ribbed cavity 208. Further, in an embodiment, the at least one stimulator may include at least one electronic vibrator. Further, the at least one electronic vibrator may be partially insertable in the ribbed cavity 208. Further, the at least one electronic vibrator may be removably insertable in the ribbed cavity 208. Further, the at least one electronic vibrator may be configured for producing vibrations. Further, the at least one electronic vibrator provides stimulation to the at least one sexual organ based on the vibrations. Further, the at least one electronic vibrator may include a bullet vibrator.

Further, the base 106 may include at least one attachment 216. Further, the at least one attachment 216 may include at least one adhesive layer. Further, the at least one attachment 216 may be attachable to the groin. Further, the groin may include a pubic bone. Further, the at least one balloon may include a first balloon and a second balloon. Further, the second balloon may be concentrically disposed around the first balloon in the shaft cavity. Further, the first balloon may be permanently inflated based on the at least one fluid disposed of in the first balloon. Further, the second balloon may be fluidly coupled with the at least one reservoir 110. Further, the second balloon may be configured for inflating based on the transferring of the at least one fluid to the second balloon. Further, the head 108 may include the at least one pocket 130 and the at least one hole 132 leading into the at least one pocket 130. Further, the at least one pocket 130 may be configured for receiving at least one first fluid through the at least one hole 132. Further, the at least one pocket 130 may be configured for storing the at least one first fluid. Further, the at least one pocket 130 may be configured for dispersing the at least one first fluid through the at least one hole 132 based on at least one squeezing action receivable by the head 108. Further, at least one of the shaft 104, the base 106, and the head 108 may include at least one material. Further, the at least one material may include at least one soft elastomer. Further, the at least one soft elastomer may include soft silicone. Further, the base 106 may form a plug. Further, at least one portion of a periphery of the plug may include at least one firmer elastomer. Further, the at least one firmer elastomer may include hard silicone. Further, the at least one pocket 130 may include at least one cavity wall. Further, the at least one cavity wall may include the at least one firmer elastomer. Further, the at least one reservoir 110 may include at least one containment sleeve disposed of in at least one container wall. Further, the second balloon may constrict the channel 122 (urethra). Further, the second balloon may stretch lengthways. Further, the second balloon may not stretch widthways. Further, the second balloon may include a containment sleeve.

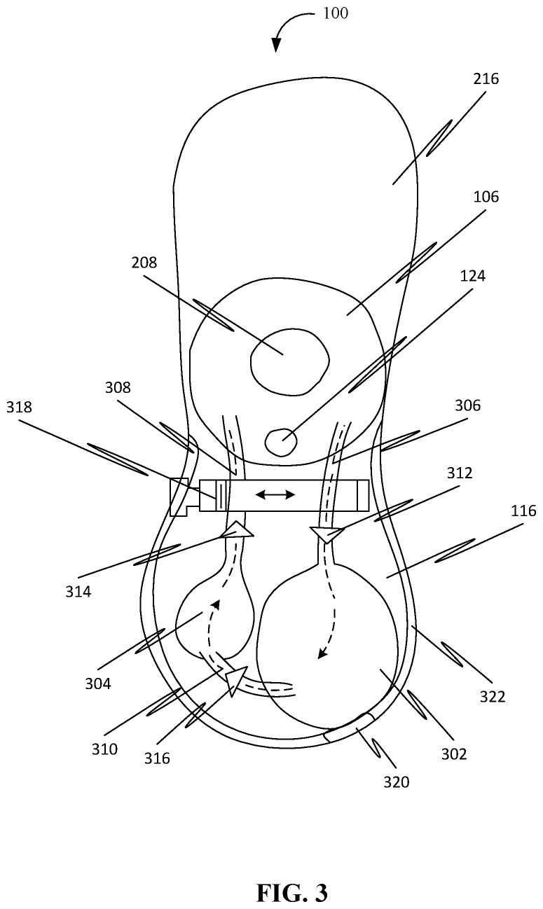

FIG. 3 is a rear cross-sectional view of the penile prosthesis device 100 for facilitating the plurality of bodily functions associated with the penis, in accordance with some embodiments. Further, the penile prosthesis device 100 may include the penile prosthesis body 102, the urinary transfer device 128, and the pump system.

Further, the at least one reservoir of the pump system may include a first reservoir 302 and a second reservoir 304. Further, the at least one fluid coupling mechanism 114 may include at least one tube. Further, the first reservoir 302, the second reservoir 304, and the at least one balloon 112 may be fluidly coupled using the at least one tube. Further, the at least one tube may include a first tube 306, a second tube 308, and a third tube 310. Further, the first reservoir 302 may be fluidly coupled with the at least one balloon 112 using the first tube 306 and the second reservoir 304 may be fluidly coupled with the at least one balloon 112 using the second tube 308. Further, the first reservoir 302 may be fluidly coupled with the second reservoir 304 using the third tube 310. Further, the at least one fluid circulates between the first reservoir 302, the second reservoir 304, and the at least one balloon 112. Further, the at least one check valve may be coupled with the at least one tube. Further, the at least one check valve may include a first check valve 312, a second check valve 314, and a third check valve 316. Further, the first check valve 312 may be coupled with the first tube 306. Further, the second check valve 314 may be coupled with the second tube 308. Further, the third check valve 316 may be coupled with the third tube 310. Further, the first check valve 312 may be configured for ensuring a flow of the at least one fluid from the at least one balloon 112 to the first reservoir 302. Further, the first check valve 312 may be configured for restricting a backflow of the at least one fluid from the first reservoir 302 to the at least one balloon 112. Further, the second check valve 314 may be configured for ensuring a flow of the at least one fluid from the second reservoir 304 to the at least one balloon 112. Further, the second check valve 314 may be configured for restricting a backflow of the at least one fluid from the at least one balloon 112 to the second reservoir 304. Further, the third check valve 316 may be configured for ensuring a flow of the at least one fluid from the first reservoir 302 to the second reservoir 304. Further, the third check valve 316 may be configured for restricting a backflow of the at least one fluid from the second reservoir 304 to the first reservoir 302. Further, the pump system may include at least one switch valve 318. Further, the at least one switch valve 318 may be coupled with the first tube 306 and the second tube 308. Further, the pump system may include at least one purge valve 320 coupled with the at least one reservoir. Further, the at least one purge valve 320 may be configured for at least one of removing and adding the at least one fluid in the at least one reservoir. Further, the appendage 116 may include a scrotum skin 322. Further, the scrotum skin 322 may include at least one material.

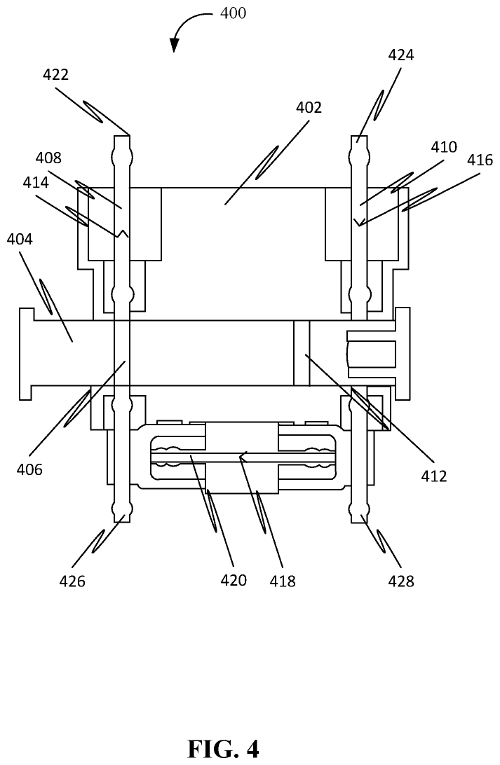

FIG. 4 is a front cross-sectional view of a switch valve 400 of a pump system, in accordance with some embodiments. Further, the switch valve 400 may be coupled with at least one fluid coupling mechanism. Further, the at least one fluid coupling mechanism may include a first tube 408 and a second tube 410. Further, a first primary end 422 of the first tube 408 may be attached to an inlet of the at least one balloon 112 disposed of in the shaft 104. Further, a second primary end 424 of the second tube 410 may be attached to an outlet of the at least one balloon 112. Further, a first secondary end 426 of the first tube 408 may be attached to a high pressure reservoir (testicle). Further, a second secondary end 428 of the second tube 410 may be attached to a low pressure reservoir (testicle). Further, the at least one fluid coupling mechanism may include a third tube 420 fluidly coupled with the first tube 408 and the second tube 410 proximal to the first secondary end 426 and the second secondary end 428. Further, the first tube 408 may include a first check valve 414. Further, the second tube 410 may include a second check valve 416. Further, the third tube 420 may include a third check valve 418. Further, the switch valve 400 may include a cylinder 402 and a rod 404 disposed within the cylinder 402. Further, the rod 404 may include a first opening 406 and a second opening 412. Further, the first opening 406 may be disposed proximal to a first end of the rod 404. Further, the second opening 412 may be disposed proximal to a second end of the rod 404. Further, the rod 404 may be movably disposed within the cylinder 402. Further, the rod 404 may be configured to move through a plurality of positions. Further, the plurality of positions may include a first position, a second position, and a neutral position. Further, the rod 404 may slide to the first position, the second position, and the neutral position. Further, the first opening 406 of the rod 404 aligns with the first tube 408 and the second opening 412 of the rod 404 does not align with the second tube 410 in the first position. Further, the switch valve 400 allows a flow of a fluid from the high pressure reservoir to the at least one balloon 112 through the first tube 408. Further, the switch valve 400 restricts a flow of a fluid from the at least one balloon 112 to the low pressure reservoir through the second tube 410.

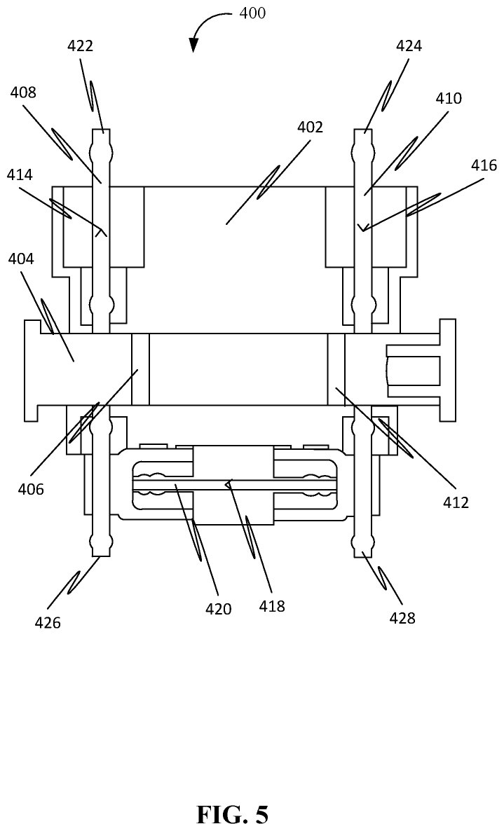

FIG. 5 is a front cross-sectional view of the switch valve 400 of the pump system, in accordance with some embodiments. Further, the first opening 406 of the rod 404 does not align with the first tube 408 and the second opening 412 of the rod 404 does not align with the second tube 410 in the neutral position. Further, the switch valve 400 restricts the flow of the fluid from the high pressure reservoir to the at least one balloon 112 through the first tube 408. Further, the switch valve 400 restricts the flow of the fluid from the at least one balloon 112 to the low pressure reservoir through the second tube 410.

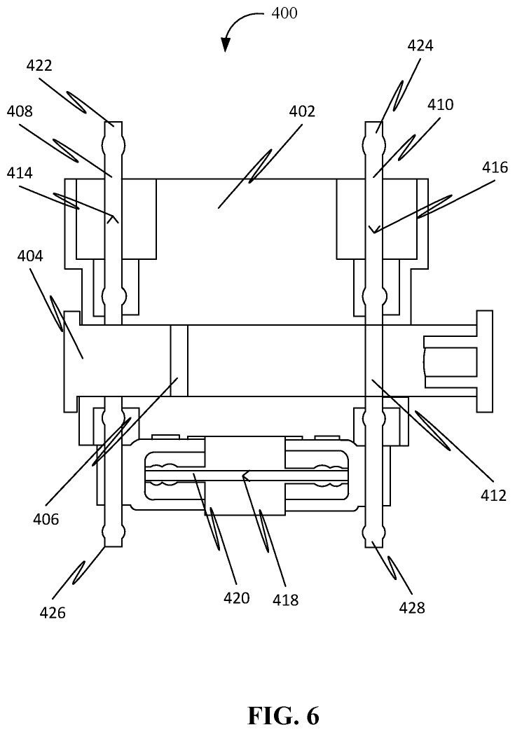

FIG. 6 is a front cross-sectional view of the switch valve 400 of the pump system, in accordance with some embodiments. Further, the first opening 406 of the rod 404 does not align with the first tube 408 and the second opening 412 of the rod 404 aligns with the second tube 410 in the second position. Further, the switch valve 400 restricts the flow of the fluid from the high pressure reservoir to the at least one balloon 112 through the first tube 408. Further, the switch valve 400 allows the flow of the fluid from the at least one balloon 112 to the low pressure reservoir through the second tube 410.

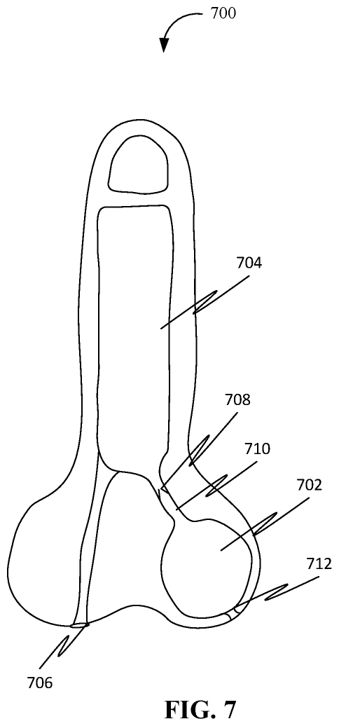

FIG. 7 is a front cross-sectional view of a penile prosthesis body 700 with a pump system, in accordance with some embodiments. Further, the pump system may be pneumatic. Further, the pump system may be manually operated. Further, the pump system may include a hand pump 702, a balloon 704, at least one check valve, and a purge valve 706. Further, the hand pump 702 may be coupled with the balloon 704 using a tube 710. Further, the tube 710 may include a first check valve 708. Further, the hand pump 702 may be configured for pumping the at least one fluid into the balloon 704 through a one way air inlet 712. Further, the at least one fluid may be air. Further, the purge valve 706 may be manually open for releasing the at least one fluid from the balloon 704.

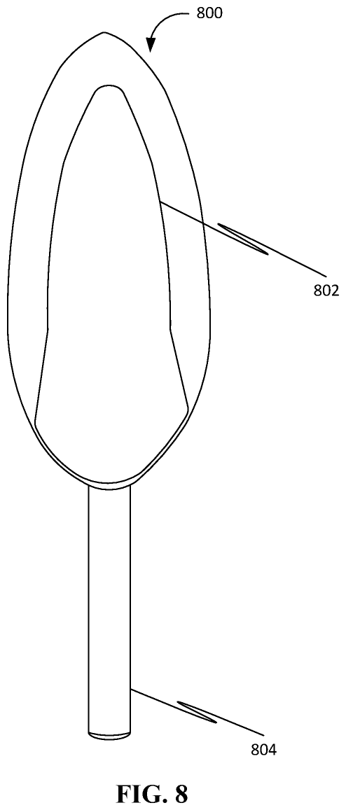

FIG. 8 is a top view of a urinary transfer device 800 of a penile prosthesis device, in accordance with some embodiments. Further, the urinary transfer device 800 may be coupled with a penile prosthesis body of the penile prosthesis device. Further, a first end 802 of the urinary transfer device 800 may be in contact with a urethral opening of the user. Further, the first end 802 may include a spill rim. Further, a second end 804 of the urinary transfer device 800 may be coupled with a first channel end of a channel disposed in a shaft of the penile prosthesis body. Further, the second end 804 may include a tube. Further, the first end 802 and the second end 804 may be fluidly coupled. Further, the urinary transfer device 800 may be configured for transferring urine discharged from the urethra to the channel. Further, the spill rim prevents the spilling of the urine discharged from the urethra at the first end 802. Further, the tube is inserted into the channel through the first channel end. Further, the tube may be firm yet pliable to keep the channel open and allow bending of the penile prosthesis device. Further, the channel may be configured for allowing a flow of the urine from a first channel end of the channel to a second channel end of the channel.

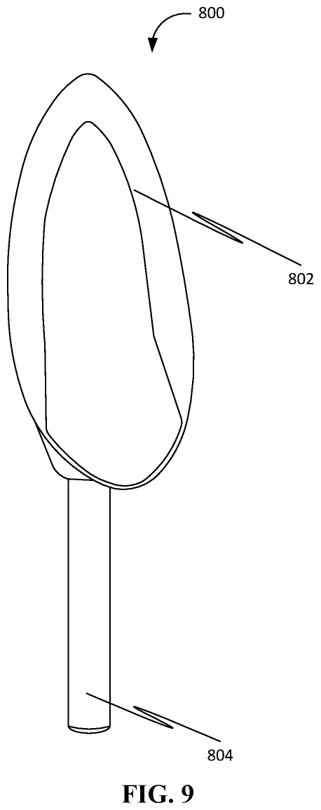

FIG. 9 is a top perspective view of the urinary transfer device 800 of the penile prosthesis device, in accordance with some embodiments.

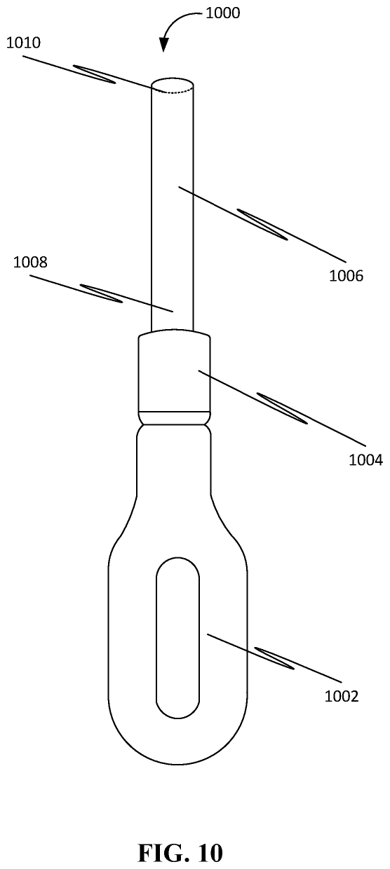

FIG. 10 is a top view of a urinary transfer device 1000 of a penile prosthesis device, in accordance with some embodiments. Further, the urinary transfer device 1000 may be coupled with a penile prosthesis body of the penile prosthesis device. Further, the urinary transfer device 1000 may include a first end 1002, a second end 1004, and a tube 1006. Further, the first end 1002 may be attachable to a urethral opening of the user. Further, the second end 1004 may be coupled with a first tube end 1008 of the tube 1006. Further, a second tube end 1010 of the tube 1006 may be insertable in a first channel end of a channel disposed in a shaft of the penile prosthesis body.

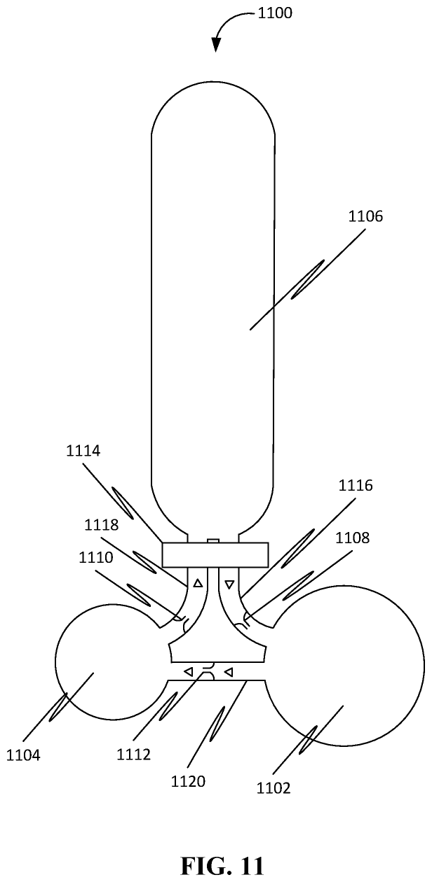

FIG. 11 is a schematic of a pump system 1100 of a penile prosthesis device, in accordance with some embodiments. Further, the pump system 1100 may be configured for actuating and de-actuating an erection in the penile prosthesis device. Further, the pump system 1100 may include a first reservoir 1102 a second reservoir 1104, at least one balloon 1106, a first check valve 1108, a second check valve 1110, a third check valve 1112, a switch valve 1114, a first tube 1116, a second tube 1118, and a third tube 1120. Further, the first check valve 1108, the second check valve 1110, and the third check valve 1112 may be one-way check valves that prevent fluid to travel in the wrong direction in the first tube 1116, the second tube 1118, and the third tube 1120. Further, the first reservoir 1102 may be squeezed to prime the fluid. Further, the actuating of the erection may include pushing the switch valve 1114 to open a left tube (the second tube 1118) and close a right tube (the first tube 1116) and releasing the high pressure fluid from a high pressure testicle (the second reservoir 1104) into the at least one balloon 1106 associated a shaft of a penile prosthesis body. Further, the de-actuating of the erection may include pushing the switch valve 1114 to open the right tube (the first tube 1116) and close the left tube (the second tube 1118) and flowing of the fluid from the at least one balloon 1106 associated with the shaft into a low pressure testicle/pump (the first reservoir 1102). Further, the low pressure testicle may be squeezed to pump the fluid into the high pressure testicle (the second reservoir 1104) to prime the penile prosthesis device for another erection.

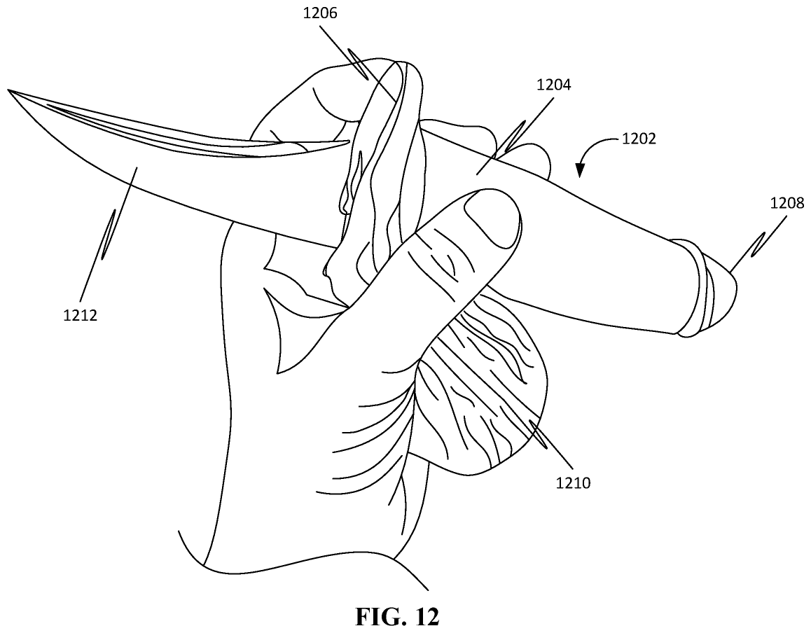

FIG. 12 is a side perspective view of a penile prosthesis body 1202 with a urinary transfer device 1212, in accordance with some embodiments. Further, the penile prosthesis body 1202 may include a shaft 1204, a head 1208, a base 1206, and an appendage 1210.

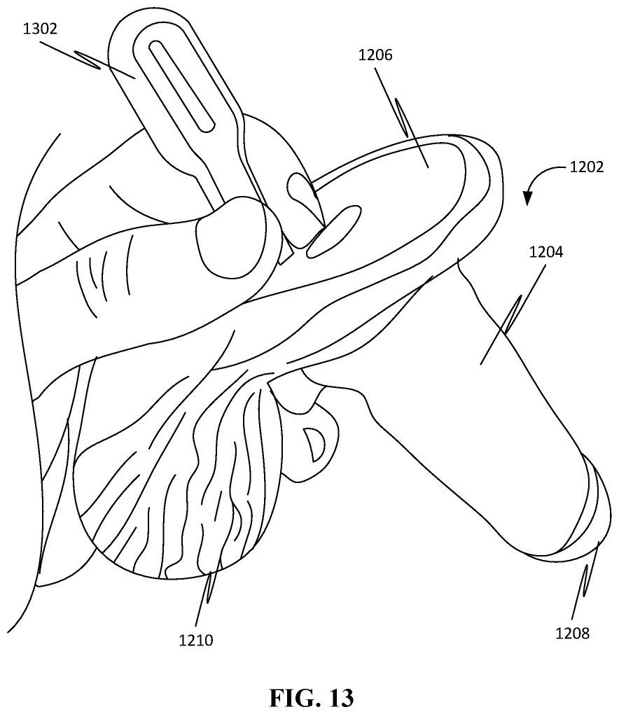

FIG. 13 is a side perspective view of the penile prosthesis body 1202 with a urinary transfer device 1302, in accordance with some embodiments.

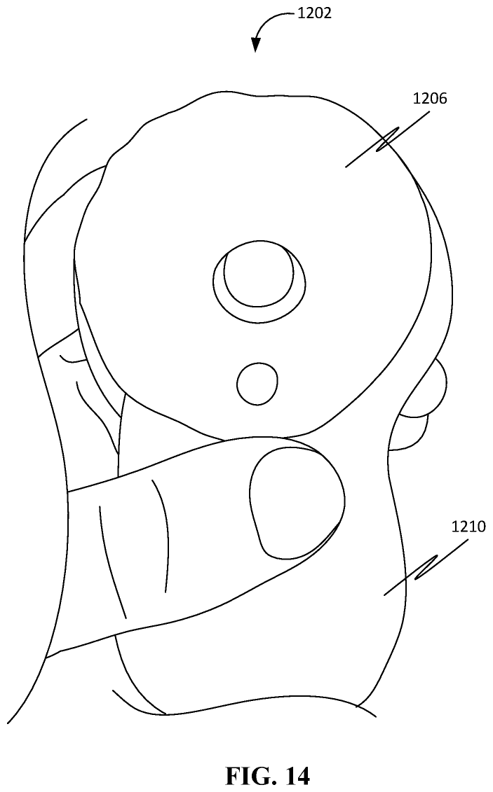

FIG. 14 is a rear view of the penile prosthesis body 1202, in accordance with some embodiments.

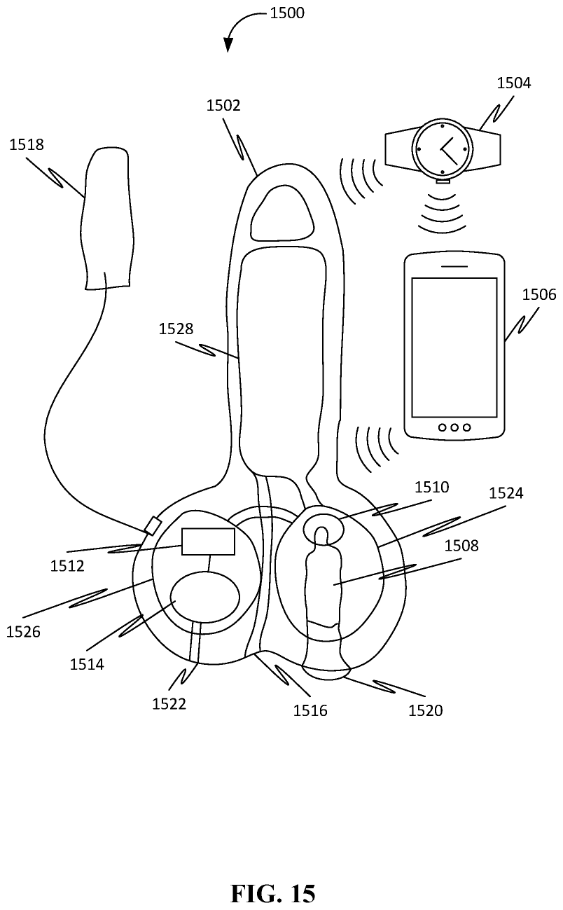

FIG. 15 is a schematic of a system 1500 with a penile prosthesis device 1502, in accordance with some embodiments. Further, the penile prosthesis device 1502 may include a micro carbon dioxide cartridge 1508, an electronic valve 1510, a controller 1512, a battery 1514, a purge valve 1516, and a tampon controller 1518.

Further, the micro carbon dioxide cartridge 1508 and the electronic valve 1510 may be disposed of in a first testicle 1524 of the penile prosthesis device 1502. Further, the electronic valve 1510 may be coupled with the micro carbon dioxide cartridge 1508. Further, the electronic valve 1510 may be configured for transferring carbon dioxide gas from the micro carbon dioxide cartridge 1508 to a balloon 1528 of the penile prosthesis device 1502. Further, the first testicle 1524 may include an opening 1520. Further, the opening 1520 may provide access to the first testicle 1524 for replacing the micro carbon dioxide cartridge 1508.

Further, the controller 1512 and the battery 1514 may be disposed of in a second testicle 1526 of the penile prosthesis device 1502. Further, the controller 1512 may include a communication system. Further, the communication system may include Bluetooth. Further, the second testicle 1526 may include an electrical interface 1522. Further, the battery 1514 may be electrically coupled with the electrical interface 1522, the controller 1512, and the electronic valve 1510. Further, the electrical interface 1522 may interface with a power source for charging the battery 1514 over at least one of a wired connection and a wireless connection. Further, the tampon controller 1518 may be coupled with the controller 1512 over a wired connection. Further, the first testicle 1524 may be electrically coupled with the second testicle 1526.

Further, the system 1500 may include a wearable device 1504 and a user device 1506. Further, the wearable device 1504 may be communicatively coupled with the penile prosthesis device 1502 and the user device 1506 through the Bluetooth. Further, the user device 1506 may be communicatively coupled with the penile prosthesis device 1502 through the Bluetooth. Further, the wearable device 1504 may include a smartwatch. Further, the user device 1506 may include a smartphone.

Further, the purge valve 1516 may be coupled with the balloon 1528. Further, the purge valve 1516 may be configured for releasing the carbon dioxide gas from the balloon 1528.

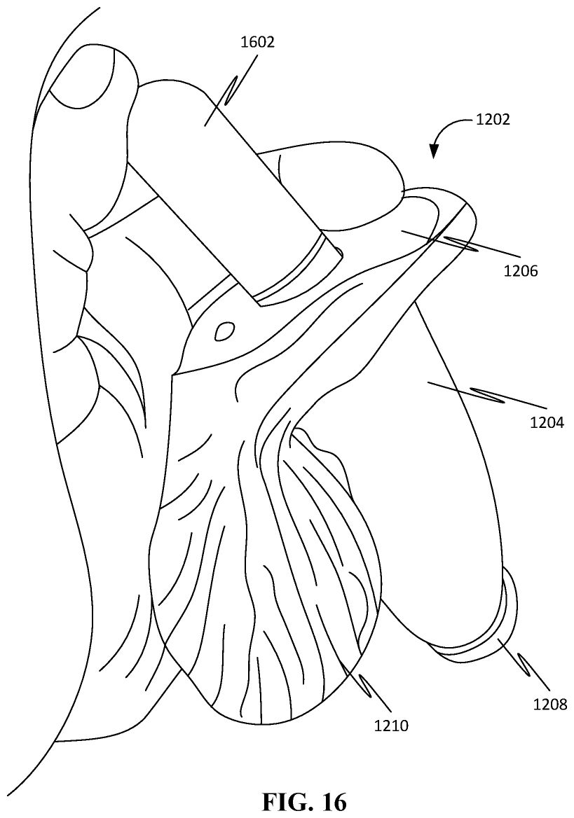

FIG. 16 is a side perspective view of the penile prosthesis body 1202 with a stimulator 1602, in accordance with some embodiments. Further, the stimulator 1602 may be coupled with the base 1206. Further, the base 1206 may include a cavity disposed on the base 1206. Further, the stimulator 1602 may be partially disposed in the cavity. Further, in an embodiment, the stimulator 1602 may include a vibrator. Further, the vibrator may be configured for producing vibrations. Further, the vibrator provides stimulation to at least one sexual organ based on the vibrations. Further, the vibrator may include Vibe. Further, in an embodiment, the vibrator may be communicatively coupled to a remote device over a wireless connection. Further, the remote device may include a remote control ring. Further, the vibrator may be operated using the remote device. Further, the vibrator may be configured for producing the vibrations by receiving a signal from the remote device.

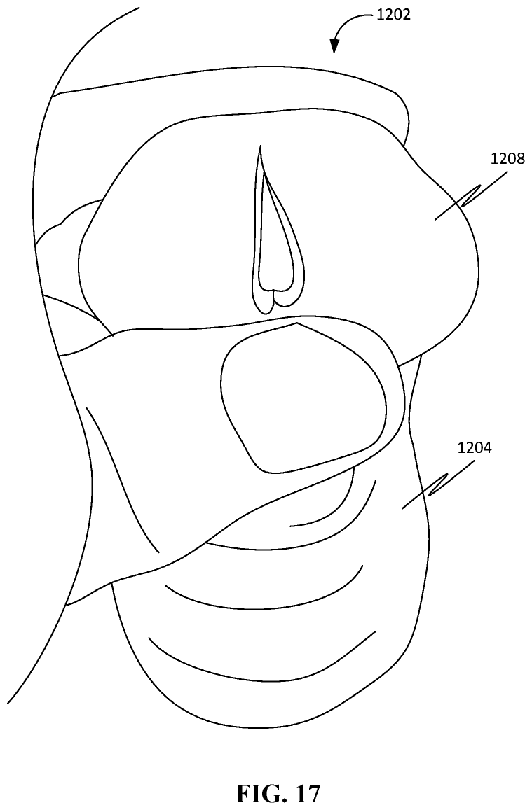

FIG. 17 is a front perspective view of the penile prosthesis body 1202, in accordance with some embodiments. Further, the head 1208 may include an opening disposed on the head 1208.

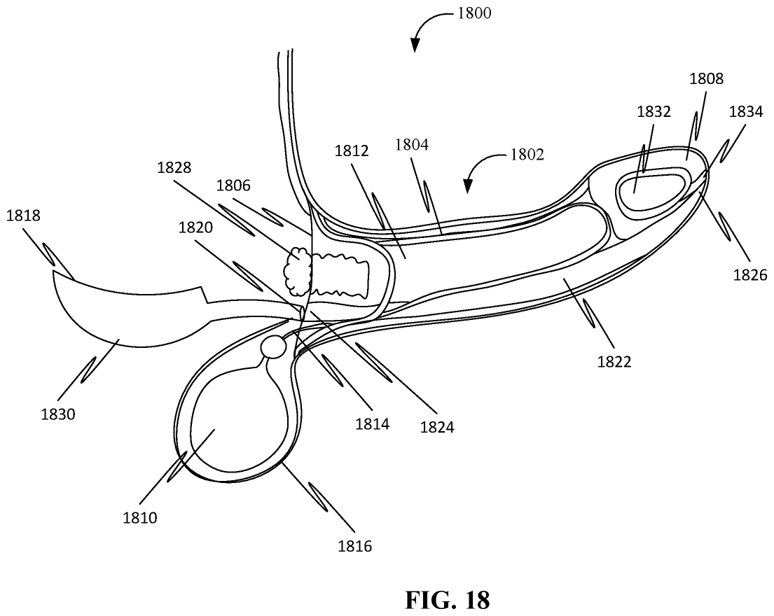

FIG. 18 is a side cross-sectional view of a penile prosthesis device 1800 for facilitating a plurality of bodily functions associated with a penis, in accordance with some embodiments. Further, the penile prosthesis device 1800 may include a penile prosthesis body 1802, a urinary transfer device 1830, an ejaculation system, a pump system, and at least one stimulator 1828.

Further, the penile prosthesis body 1802 may include a shaft 1804, a head 1808, a base 1806, and an appendage 1816. Further, the head 1808 may be included in a distal end of the penile prosthesis body 1802. Further, the base 1806 may be included in a proximal end of the penile prosthesis body 1802. Further, the penile prosthesis body 1802 may include a channel 1822 extending from the base 1806 to the head 1808 along the shaft 1804. Further, the channel 1822 may include a first channel end 1824 and a second channel end 1826. Further, the first channel end 1824 may be disposed on the base 1806 and the second channel end 1826 may be disposed on the head 1808. Further, the appendage 1816 may be attached to the proximal end. Further, the base 1806 may be configured to be in contact with a groin of a user.

Further, the ejaculation system may include a lubrication system. Further, the ejaculation system may include at least one pocket 1832 and at least one hole 1834 leading into the at least one pocket 1832. Further, the at least one pocket 1832 may be disposed of in the head 1808. Further, the at least one hole 1834 may be disposed on the head 1808. Further, the at least one pocket 1832 may include at least one first fluid disposed in the at least one pocket 1832. Further, the at least one pocket 1832 may be configured for dispersing the at least one first fluid through the at least one hole 1834 based on at least one action receivable by the head 1808. Further, the at least one action may include at least one squeezing action. Further, the at least one first fluid may include at least one liquid, at least one semi-liquid, at least one gel, etc. Further, the at least one first fluid may include at least one lubricant, at least one ejaculate, etc. Further, the at least one ejaculate may include at least one synthetic semen. Further, the at least one lubricant may include a water-based lubricant, an oil-based lubricant, a silicone-based lubricant, etc.

Further, the urinary transfer device 1830 may be coupled with the penile prosthesis body 1802. Further, a first end 1818 of the urinary transfer device 1830 may be in contact with a urethral opening of the user. Further, a second end 1820 of the urinary transfer device 1830 may be coupled with the first channel end 1824. Further, the first end 1818 and the second end 1820 may be fluidly coupled. Further, the urinary transfer device 1830 may be configured for transferring urine discharged from the urethra to the channel 1822. Further, the channel 1822 may be configured for allowing a flow of the urine from the first channel end 1824 to the second channel end 1826.

Further, the pump system may be coupled with the penile prosthesis body 1802. Further, the pump system may include at least one reservoir 1810 and at least one balloon 1812. Further, the at least one reservoir 1810 may be disposed of in an appendage cavity of the appendage 1816. Further, the at least one balloon 1812 may be disposed of in a shaft cavity of the shaft 1804. Further, the at least one reservoir 1810 may be fluidly coupled with the at least one balloon 1812 using at least one fluid coupling mechanism 1814. Further, the at least one reservoir 1810 may include at least one fluid. Further, the at least one reservoir 1810 may be configured for transferring the at least one fluid to the at least one balloon 1812. Further, the at least one balloon 1812 may be configured for inflating based on the transferring. Further, the shaft 1804 may be configured for transitioning to an erect state based on the inflating.

Further, the at least one stimulator 1828 may be disposed on the base 1806. Further, the at least one stimulator 1828 may include at least one stimulating surface. Further, the at least one stimulating surface may be configured for engaging with at least one sexual organ of the user. Further, the at least one stimulator 1828 provides stimulation to the at least one sexual organ based on the engaging of the at least one stimulating surface with the at least one sexual organ. Further, the at least one stimulator 1828 provides stimulation to the at least one sexual organ based on the engaging with the at least one sexual organ. Further, in an embodiment, the at least one stimulator 1828 may include a ribbed cavity. Further, the ribbed cavity may be disposed on the base 1806. Further, the ribbed cavity may include at least one protrusion disposed on a wall of the ribbed cavity. Further, the ribbed cavity may be configured for receiving at least one portion of the at least one sexual organ. Further, the receiving of the at least one portion of the at least one sexual organ in the ribbed cavity provides stimulation to the at least one sexual organ. Further, the at least one sexual organ may be a clitoris.

Although the present disclosure has been explained in relation to its preferred embodiment, it is to be understood that many other possible modifications and variations can be made without departing from the spirit and scope of the disclosure.

The following is claimed:

1. A penile prosthesis device for facilitating a plurality of bodily functions associated with a penis, the penile prosthesis device comprising:
a penile prosthesis body comprising a shaft, a head, a base, and an appendage, wherein the head is comprised in a distal end of the penile prosthesis body, wherein the base is comprised in a proximal end of the penile prosthesis body, wherein the appendage is attached to the proximal end, wherein the base is configured to be in contact with the groin of a user;
an ejaculation system comprising at least one pocket and at least one hole leading into the at least one pocket, wherein the at least one pocket is disposed of in the head, wherein the at least one hole is disposed on the head, wherein the at least one pocket comprises at least one first fluid disposed in the at least one pocket, wherein the at least one pocket is configured for dispersing the at least one first fluid through the at least one hole based on at least one action receivable by the head; and
a pump system coupled with the penile prosthesis body, wherein the pump system comprises at least one reservoir and at least one balloon, wherein the at least one reservoir is disposed of in an appendage cavity of the appendage, wherein the at least one balloon is disposed of in a shaft cavity of the shaft, wherein the at least one reservoir is fluidly coupled with the at least one balloon using at least one fluid coupling mechanism, wherein the at least one reservoir comprises at least one fluid, wherein the at least one reservoir is configured for transferring the at least one fluid to the at least one balloon, wherein the at least one balloon is configured for inflating and deflating based on the transferring, wherein the shaft is configured for transitioning to an erect state based on the inflating, wherein the at least one balloon is configured for transferring the at least one fluid disposed of in the at least one balloon to the at least one reservoir using the at least one fluid coupling mechanism, wherein the at least one balloon is configured for deflating based on the transferring of the at least one fluid from the at least one balloon, wherein the shaft is configured for transitioning to a flaccid state based on the deflating, wherein the shaft is characterized by at least one of a rigidity and a length, wherein the at least one of the rigidity and the length of the shaft is greater in the erect state than the at least one of the rigidity and the length of the shaft in the flaccid state. The penile prosthesis device of claim 1 further comprising at least one stimulator disposed on the base, wherein the at least one stimulator comprises at least one stimulating surface, wherein the at least one stimulating surface is configured for engaging with at least one sexual organ of the user, wherein the at least one stimulator provides stimulation to the at least one sexual organ based on the engaging of the at least one stimulating surface with the at least one sexual organ.

2. The penile prosthesis device of claim 1, wherein the at least one reservoir is configured for priming the at least one fluid disposed of in the at least one reservoir based on at least one squeezing action receivable by the at least one reservoir, wherein the transferring of the at least one fluid from the at least one reservoir to the at least one balloon through the at least one fluid coupling mechanism is based on the priming.

3. The penile prosthesis device of claim 2, wherein the pump system comprises at least one check valve coupled with the at least one fluid coupling mechanism, wherein the at least one check valve is configured for ensuring a flow of the at least one fluid in a single direction through the at least one fluid coupling mechanism, wherein the at least one check valve is configured for preventing a backflow of the at least one fluid through the at least one fluid coupling mechanism.

4. The penile prosthesis device of claim 3, wherein the pump system comprises at least one switch valve coupled with the at least one fluid coupling mechanism, wherein the at least one switch valve is configured for transitioning between an engaged state and a disengaged state, wherein the at least one switch valve is configured for restricting a flow of the at least one fluid through the at least one fluid coupling mechanism in the engaged state, wherein the at least one switch valve is configured for allowing the flow of the at least one fluid through the at least one fluid coupling mechanism in the disengaged state.

5. The penile prosthesis device of claim 4, wherein the at least one reservoir comprises a first reservoir and a second reservoir, wherein the at least one fluid coupling mechanism comprises at least one tube, wherein the first reservoir, the second reservoir, and the at least one balloon are fluidly coupled using the at least one tube, wherein the at least one tube comprises a first tube, a second tube, and a third tube, wherein, the first reservoir is fluidly coupled with the at least one balloon using the first tube and the second reservoir is fluidly coupled with the at least one balloon using the second tube, wherein the first reservoir is fluidly coupled with the second reservoir using the third tube, wherein the at least one fluid circulates between the first reservoir, the second reservoir, and the at least one balloon, wherein the at least one check valve is coupled with the at least one tube, wherein the at least one check valve comprises a first check valve, a second check valve, and a third check valve, wherein the first check valve is coupled with the first tube, wherein the second check valve is coupled with the second tube, wherein the third check valve is coupled with the third tube, wherein the first check valve is configured for ensuring a flow of the at least one fluid from the at least one balloon to the first reservoir, wherein the first check valve is configured for restricting a backflow of the at least one fluid from the first reservoir to the at least one balloon, wherein the second check valve is configured for ensuring a flow of the at least one fluid from the second reservoir to the at least one balloon, wherein the second check valve is configured for restricting a backflow of the at least one fluid from the at least one balloon to the second reservoir, wherein the third check valve is configured for ensuring a flow of the at least one fluid from the first reservoir to the second reservoir, wherein the third check valve is configured for restricting a backflow of the at least one fluid from the second reservoir to the first reservoir, wherein the at least one switch valve comprises a first switch valve and a second switch valve, wherein the first switch valve is coupled with the first tube and the second switch valve is coupled with the second tube, wherein the first switch valve is configured for preventing a flow of the at least one fluid between the at least one balloon and the first reservoir in the engaged state, wherein the first switch valve is configured for allowing the flow of the fluid between the at least one balloon and the first reservoir in the disengaged state, wherein the second switch valve is configured for preventing a flow of the at least one fluid between the second reservoir and the at least one balloon in the engaged state, wherein the second switch valve is configured for allowing the flow of the at least one fluid between the second reservoir and the at least one balloon in the disengaged state.

6. The penile prosthesis device of claim 5, wherein the at least one fluid is disposed in the first reservoir, wherein the first reservoir is configured for receiving a squeezing action for priming the at least one fluid, wherein the first reservoir is configured for transferring the at least one fluid to the second reservoir through the third tube based on the engaged state of the first switch valve, wherein the second reservoir is configured for transferring the at least one fluid to the at least one balloon through the second tube based on the disengaged state of the second switch valve, wherein the inflating is based on the transferring of the at least one fluid to the at least one balloon, wherein the shaft is configured for transitioning to the erect state based on the inflating, wherein the at least one balloon transfers the at least one fluid to the first reservoir through the first tube based on the disengaged state of the first switch valve, wherein the shaft is configured for transitioning to a flaccid state based on the transfer of the at least one fluid from the at least one balloon to the first reservoir.

7. The penile prosthesis device of claim 6, wherein the shaft comprises at least one containment sleeve disposed around the shaft, wherein the at least one containment sleeve is configured for allowing an expansion of the shaft along a length of the shaft based on the inflating, wherein the at least one containment sleeve is configured for restricting the expansion of the shaft along a width of the shaft based on the inflating.

8. The penile prosthesis device of claim 1, wherein the base comprises a disc-shaped structure, wherein a thickness of the disc-shaped structure is smaller than a diameter of the disc-shaped structure, wherein the diameter of the disc-shaped structure is larger than a diameter of the shaft, wherein the disc-shaped structure comprises a concave surface, wherein the concave surface is in contact with a skin of the groin using at least one attachment.

9. The penile prosthesis device of claim 8, wherein the at least one switch valve is configured to move between a plurality of positions, wherein the plurality of positions comprises a first position, a second position, and a neutral position, wherein the first switch valve transitions to the disengaged state and the second switch valve transitions to the engaged state in the first position, wherein the first switch valve allows the flow of the at least one fluid and the second switch valve prevents the flow of the at least one fluid in the first position, wherein the first switch valve transitions to the engaged state and the second switch valve transitions to the disengaged state in the second position, wherein the first switch valve prevents the flow of the at least one fluid and the second switch valve allows the flow of the at least one fluid in the second position, wherein the first switch valve transitions to the engaged state and the second switch valve transitions to the engaged state in the neutral position, wherein the first switch valve prevents the flow of the at least one fluid and the second switch valve prevents the flow of the at least one fluid in the neutral position.

10. The penile prosthesis device of claim 1, wherein the penile prosthesis body comprises a channel extending from the base to the head along the shaft, wherein the channel comprises a first channel end and a second channel end, wherein the first channel end is disposed on the base and the second channel end is disposed on the head.

11. The penile prosthesis device of claim 1, wherein the pump system comprises at least one inflation mechanism, wherein the at least one inflation mechanism is electrically powered, wherein the at least one inflation mechanism is configured for performing at least one pumping action, wherein the at least one inflation mechanism is configured for transferring the at least one fluid from the at least one reservoir to the at least one balloon through the at least one fluid coupling mechanism based on the performing of the at least one inflation action.

12. The penile prosthesis device of claim 11 further comprising:
at least one sensor disposable at least one body part of the user, wherein the at least one sensor is configured for generating sensor data based on at least one of a physical state and a physiological state of the user; and
a processing device communicatively coupled with the at least one sensor, wherein the processing device is configured for:
analyzing the sensor data; and
determining an arousal state of the user based on the analyzing, wherein the at least one inflation mechanism is communicatively coupled with the processing device, wherein the performing of at least one pumping action is based on the determining of the arousal state.

13. The penile prosthesis device of claim 12 further comprising:
at least one first sensor disposable in a vagina of the user, wherein the at least one first sensor is configured for generating first sensor data based on at least one voluntary movement of pelvic floor muscles associated with the vagina; and
a processing device communicatively coupled with the at least one first sensor, wherein the processing device is configured for:
analyzing the first sensor data; and
determining an arousal state of the user based on the analyzing of the first sensor data, wherein the at least one inflation mechanism is communicatively coupled with the processing device, wherein the performing of the at least one pumping action is based on the determining of the arousal state, wherein the performing of the at least one pumping action transitions the shaft from a first erect state and a second erect, wherein the shaft is characterized by at least one of a rigidity and a length, wherein at least one of a first rigidity and a first length corresponding to the first erect state is less than at least one of a second rigidity and a second length corresponding to the second erect state.

14. The penile prosthesis device of claim 13 further comprising at least one second sensor disposed on the shaft, wherein the at least one second sensor is configured for generating second sensor data based on at least one pressure and at least one movement receivable by the shaft, wherein the processing device is configured for analyzing the second sensor data, wherein the determining of the arousal state is based on the analyzing of the second sensor data.

15. The penile prosthesis device of claim 1, wherein the at least one reservoir comprises at least one carbon dioxide gas cartridge, wherein the at least one fluid comprises carbon dioxide gas, wherein the at least one carbon dioxide gas cartridge is configured for transferring the carbon dioxide gas to the at least one balloon, wherein the inflating is based on the transferring of the carbon dioxide gas.

16. The penile prosthesis device of claim 12 further comprising a urinary transfer device coupled with the penile prosthesis body, wherein a first end of the urinary transfer device is in contact with a urethral opening of the user, wherein a second end of the urinary transfer device is coupled with the first channel end, wherein the first end and the second end are fluidly coupled, wherein the urinary transfer device is configured for transferring urine discharged from the urethra to the channel, wherein the channel is configured for allowing a flow of the urine from the first channel end to the second channel end.

17. A penile prosthesis device for facilitating a plurality of bodily functions associated with a penis, the penile prosthesis device comprising:
a penile prosthesis body comprising a shaft, a head, a base, and an appendage, wherein the head is comprised in a distal end of the penile prosthesis body, wherein the base is comprised in a proximal end of the penile prosthesis body, wherein the penile prosthesis body comprises a channel extending from the base to the head along the shaft, wherein the channel comprises a first channel end and a second channel end, wherein the first channel end is disposed on the base and the second channel end is disposed on the head, wherein the appendage is attached to the proximal end, wherein the base is configured to be in contact with a groin of a user;
an ejaculation system comprising at least one pocket and at least one hole leading into the at least one pocket, wherein the at least one pocket is disposed of in the head, wherein the at least one hole is disposed on the head, wherein the at least one pocket comprises at least one first fluid disposed in the at least one pocket, wherein the at least one pocket is configured for dispersing the at least one first fluid through the at least one hole based on at least one action receivable by the head;
a urinary transfer device coupled with the penile prosthesis body, wherein a first end of the urinary transfer device is in contact with a urethral opening of the user, wherein a second end of the urinary transfer device is coupled with the first channel end, wherein the first end and the second end are fluidly coupled, wherein the urinary transfer device is configured for transferring urine discharged from the urethra to the channel, wherein the channel is configured for allowing a flow of the urine from the first channel end to the second channel end;
a pump system coupled with the penile prosthesis body, wherein the pump system comprises at least one reservoir and at least one balloon, wherein the at least one reservoir is disposed of in an appendage cavity of the appendage, wherein the at least one balloon is disposed of in a shaft cavity of the shaft, wherein the at least one reservoir is fluidly coupled with the at least one balloon using at least one fluid coupling mechanism, wherein the at least one reservoir comprises at least one fluid, wherein the at least one reservoir is configured for transferring the at least one fluid to the at least one balloon, wherein the at least one balloon is configured for inflating based on the transferring, wherein the shaft is configured for transitioning to an erect state based on the inflating; and
at least one stimulator disposed on the base, wherein the at least one stimulator comprises at least one stimulating surface, wherein the at least one stimulating surface is configured for engaging with the at least one sexual organ of the user, wherein the at least one stimulator provides stimulation to the at least one sexual organ based on the engaging of the at least one stimulating surface with the at least one sexual organ.
